(19) United States
(12) Patent Application Publication
(10) Pub. No.: US 2013/0084619 A1
(43) Pub. Date: Apr. 4, 2013

(54) MODIFIED CELLULASES WITH ENHANCED THERMOSTABILITY

(71) Applicants: Edward A. Bayer, Ramot Hashavim (IL); Michael Anbar, Tel Aviv (IL)

(72) Inventors: Edward A. Bayer, Ramot Hashavim (IL); Michael Anbar, Tel Aviv (IL)

(73) Assignee: YEDA RESEARCH AND DEVELOPMENT CO. LTD., Rehovot (IL)

(21) Appl. No.: 13/702,711

(22) PCT Filed: Jun. 6, 2011
(86) PCT No.: PCT/IL11/00447

§ 371 Date: Dec. 7, 2012

Related U.S. Application Data
(60) Provisional application No. 61/473,825, filed on Apr. 11, 2011.

(51) Int. Cl. C12N 9/42; C12N 1/20

(52) U.S. Cl. CPC C12Y 302/01004
USPC 435/188; 435/209; 536/23.2; 435/320.1; 435/252.33; 435/277

(57) ABSTRACT

The present invention relates to modified family-8 cellulases that exhibit enhanced thermostability compared to the corresponding wild-type enzyme, polynucleotides encoding the modified cellulases, compositions comprising same and uses thereof. The variant family-8 cellulases are advantageous for the bioconversion process of cellulosic substrates.

### FIELD OF THE INVENTION

The present invention relates to variant family-8 cellulases comprising at least one amino acid substitution introduced into their catalytic domain and having enhanced thermostability compared to the wild-type enzymes. Such cellulases are advantageous for the bioconversion process of cellulosic substrates.

### BACKGROUND OF THE INVENTION

Efficient enzymatic saccharification of cellulose to soluble sugars is of growing interest in the biofuel industry as a source of renewable energy. Cellulose, the major component of the plant cell wall, is composed of long β-1,4 linked D-glucose molecules and is the largest carbon source on earth. The last two decades have seen tremendous progress in research on conversion of cellulosic biomass to biofuels. Nevertheless, many techno-economic challenges must be overcome before cellulosic fuel will be able to compete with corn ethanol and conventional sources of fossil fuel. A major bottleneck in converting cellulose to fuels is the hydrolysis of plant cell wall biopolymers, especially the attack on highly recalcitrant cellulose fibers.

Cellulases are structurally and functionally diverse set of enzymes which hydrolyze the β-1,4 glycosidic bonds in the cellulose. Enzymatic hydrolysis of cellulose requires the synergistic action of at least three classes of enzymes: endoglucanases, also referred to as endocellulases, which catalyze the hydrolysis of internal bonds inside the cellulose chain and randomly produce new chain ends; exoglucanases, also referred to as exocellulases, which cleave the cellulose chain at the exposed ends, typically producing cellobiose; and β-glucosidases, which cleave short cellodextrins, notably cellobiose, into glucose. These three groups of enzymes act synergistically in order to efficiently degrade recalcitrant cellulosic substrates.

The cellulases are part of a larger group of enzymes collectively referred as glycoside hydrolases, which hydrolyze glycosidic bonds between two or more carbohydrates or between a carbohydrate and a non-carbohydrate moiety. The glycoside hydrolases are divided into families numbered in ascending order based on sequence similarities of the catalytic domain. Cellulases are assigned to several glycoside hydrolases families. Information about the classification system is available on the Carbohydrate-Active Enzymes (CAZy) server (www.cazy.org) and CAZypedia database (www.cazypedia.org) (Cantarel et al., Nucleic Acids Res, 2009, 37(Database issue): p. D233-8). Typically, cellulases (as well as other carbohydrate active enzymes) are characterized by a multi-modular organization, where the catalytic module is associated with one or more ancillary, helper, modules which modulate the enzyme activity. Each module or domain comprises a consecutive portion of the polypeptide chain and forms an independently folding, structurally and functionally distinct unit. For example, one of the main ancillary modules is the carbohydrate-binding module.

Cellulolytic microorganisms produce a wide range of enzymes that hydrolyze cellulose. For example, the thermophilic anaerobic bacterium, Clostridium thermocellum, produces a large multi-enzyme complex of cellulases, hemicellulases and other carbohydrate-active enzymes termed the cellulosome, which can efficiently degrade and solubilize crystalline cellulosic substrates. The cellulosome complex is characterized by a strong bi-modular protein-protein interaction between “cohesin” and “dockerin” modules that integrates the various enzymes into the complex. The cohesin modules are part of “scaffoldin” subunits (non-enzymatic protein components), which incorporate the enzymes into the complex via their resident dockerins. The primary scaffoldin subunit also includes a carbohydrate (e.g., cellulose)-binding module (CBM) through which the complex recognizes and binds to the cellulosic substrate.

One of the most important endoglucanases of C. thermocellum is Cellulase 8A (Cel8A). This family-8 glycoside hydrolase is the most prevalent endoglucanase secreted extracellularly as a component of the cellulosome complex. The enzyme consists of a signal peptide segment (cleaved upon secretion), a catalytic module, which folds into an (α/α)₆ barrel formed by six inner and six outer a helices, and a type I dockerin at its C-terminus that anchors the enzyme to the extracellular cellulosome complex of the bacterium. The enzyme was cloned and expressed previously in Escherichia coli (Schwarz et al., Appl Environ Microbiol 1986, 51: 1293) and crystallized to elucidate its enzyme structure and catalytic mechanism (Alzari et al., Structure 1996, 4: 265).

Optimizing the biodegradation of lignocellulose substrates requires either the search for novel enzymes which are robust enough to withstand the industrial process or alternatively, enzymes that can be engineered to enhance desired qualities, such as high specific activity, low levels of end-product inhibition, tolerance to broad ranges of pH and inhibitors of byproducts of degradation. In addition, one of the major challenges today is to reduce the cost of biofuel production in order to reach future goals of substituting renewable sources of energy for fossil-based fuels. Cellulases are relatively costly enzymes and a reduction in cost can greatly benefit their commercial use. Thermostable cellulases may offer many benefits in the bioconversion process; including, for example, improvement in stability for longer periods, enhancement of specific activity, inhibition of microbial growth, increase in mass transfer rate due to lower fluid viscosity, and greater flexibility in the bioprocess.

There are three main approaches to enhancing the thermostability of protein biocatalysts: i) directed evolution; ii) rational design and iii) data-driven design (also referred to as consensus-guided mutagenesis), by construction of synthetic consensus genes. It has been demonstrated that large stability differences could be accomplished by inducing only one or very few amino acid substitutions (Bloom et al., Proc Natl Acad Sci USA 2009, 106 Suppl 1: 9995). Other factors, such as increased internal hydrophobicity, increased hydrophobicity of the protein surface and electrostatic interactions as well as hydrogen bonding are responsible for a more rigid and stable protein (Machius et al., J Biol Chem 2003, 278: 11546). Nevertheless, despite many successful efforts to understand the structural basis of protein stability, there is still no unique paradigm of thermostable structures. Because the structure—function relationship is not known or fully understood for the majority of proteins, many mutational strategies that lead to high stability cannot easily be defined or rationalized.

Directed evolution provides a powerful approach for improving thermostability through generation of random genetic libraries (Giver et al., Proc Natl Acad Sci USA 1998, 95: 12809). This method, in combination with high-throughput screening, can be used even in cases where no information on the 3D structure exists.

Consensus-guided mutagenesis takes advantage of the large number of available protein sequences. This semi-rational approach is a well-established strategy to improve the thermostability and has been used successfully on both enzymatic and non-enzymatic proteins (see for example, Amin et al., Protein Eng Des Sel, 2004. 17(11): p. 787-93; Lehmann et al., Protein Eng, 2002 15(5): p. 403-11; and Polizzi et al., Biotechnol J, 2006. 1(5): p. 531-6). The approach is based on the substitution of specific amino acids in a particular protein with the most prevalent amino acid present at these positions among homologous family members.

The engineering of an enhanced thermostable Cel8A from C. thermocellum have been described in several publications, all published after the priority date of the present application: Anbar et al., Chem Cat Chem, 2010. 2(8): p. 997-1003, by some of the inventors of the present invention; Yi et al., Bioresour Technol, 2010 102(3): p. 3636-8; and Yi and Wu, Biotechnol Lett, 2010 32(12):1869-75.

There is an unmet need for cellulolytic enzymes with improved thermostability. For example, it would be beneficial to have modified cellulases that show high thermostability while maintaining high specific activity towards the substrate.

### SUMMARY OF THE INVENTION

The present invention provides modified family-8 cellulases that exhibit enhanced thermostability compared to the corresponding wild-type enzymes. According to some exemplary embodiments, derivatives of the endocellulase Cel8A from Clostridium thermocellum are provided. The present invention further provides polynucleotides encoding the modified cellulases, compositions comprising same and uses thereof.

The present invention discloses for the first time that by replacing one or more amino acids at the catalytic domain of family-8 cellulases, a significant increase in the thermostability of the enzyme could be achieved. The present invention discloses several specific mutations in the catalytic domain of family-8 cellulases that confer enhanced thermostability. Advantageously, thermostability can be enhanced while maintaining high specific activity towards the substrate. The present invention is based in part on the unexpected increase in the thermostability of C. thermocellum Cel8A that was obtained using a combination of directed evolution strategy and consensus-guided mutagenesis. As exemplified herein below, the activity of the mutant is maintained even after exposure to 80° C. or more.

According to one aspect, the present invention provides a bio-engineered polypeptide variant of a family-8 cellulase comprising at least one amino acid substitution introduced into the catalytic domain of the enzyme and having an enhanced thermostability compared to the unaltered sequence.

As used herein, the term “bio-engineered” indicates that the variant is made artificially and does not occur in nature. It is to be explicitly understood that naturally-occurring sequences are excluded from the scope of the present invention. Accordingly, naturally-occurring enzymes comprising the amino acid substitutions disclosed herein are excluded from the scope of the present invention.

In some embodiments, the variant comprises a non-native glycine (G) at the position corresponding to position 329 of C. thermocellum Cel8A.

As used herein, the term “non-native”, when referring to an amino acid present at a certain position, means “does not naturally occur in nature”.

The positions of the amino acid substitutions of the present invention are determined from sequence alignment of the unaltered family-8 sequence to be modified with the amino acid sequence of the wild-type C. thermocellum Cel8A. The sequence of the naturally occurring, wild-type Cel8A from C. thermocellum (Accession No. AAA83521) is set forth in SEQ ID NO.1. The DNA encoding the wild-type Cel8A (Accession No. K03088) is set forth in SEQ ID NO.2.

In some embodiments, the variant further comprises an additional substitution selected from the group consisting of a non-native arginine (R) at the position corresponding to position 276 of C. thermocellum Cel8A, and non-native threonine (T) at the position corresponding to position 375 of C. thermocellum Cel8A. Each possibility represents a separate embodiment of the invention.

In some embodiments, the variant comprises a non-native glycine (G) at the position corresponding to position 329 of C. thermocellum Cel8A, a non-native arginine (R) at the position corresponding to position 276 of C. thermocellum Cel8A, and a non-native threonine (T) at the position corresponding to position 375 of C. thermocellum Cel8A.

In some embodiments, the variant comprises a non-native glycine (G) at the position corresponding to position 329 of C. thermocellum Cel8A, a non-native arginine (R) at the position corresponding to position 276 of C. thermocellum Cel8A, a non-native threonine (T) at the position corresponding to position 375 of C. thermocellum Cel8A., and a non-native proline (P) at the position corresponding to position 283 of C. thermocellum Cel8A.

In some embodiments, the variant comprises a non-native proline (P) at the position corresponding to position 283 of C. thermocellum Cel8A.

In some embodiments, a bio-engineered polypeptide variant of the endoglucanase Cel8A from C. thermocellum is provided.

In some embodiments, the variant Cel8A comprises a serine (S) to glycine (G) substitution at position 329 of the polypeptide chain. In some exemplary embodiments, the protein sequence of the variant is as set forth in SEQ ID NO: 5.

As exemplified hereinbelow, this single mutation (S329G) serves to increase the Tₘ by 7.0° C. and the half-life of activity by 8 fold at 85° C.

In some embodiments, the variant Cel8A further comprises an additional substitution selected from the group consisting of lysine (K) to arginine (R) substitution at position 276 of the polypeptide chain and serine (S) to threonine (T) substitution at position 375 of the polypeptide chain. Each possibility represents a separate embodiment of the invention. In some exemplary embodiments, the protein sequence of the variant is selected from the group consisting of the sequences set forth in SEQ ID NO: 9 and SEQ ID NO: 43. Each possibility represents a separate embodiment of the invention:

In some embodiments, an isolated polypeptide variant of Cel8A from C. thermocellum is provided, the variant comprises a serine (S) to glycine (G) substitution at position 329 of the polypeptide chain, a lysine (K) to arginine (R) substitution at position 276 of the polypeptide chain and a serine (S) to threonine (T) substitution at position 375 of the polypeptide chain. In some specific embodiments, the protein sequence of the variant is as set forth in SEQ ID NO. 13.

As exemplified hereinbelow, the combination of these three amino acid substitutions results in a variant that exhibits a significant increase in thermal resistance, without substantial alteration of kinetic parameters compared to the wild-type enzyme.

In some embodiments, an bio-engineered polypeptide variant of Cel8A from C. thermocellum is provided, the variant comprises a serine (S) to glycine (G) substitution at position 329 of the polypeptide chain, a lysine (K) to arginine (R) substitution at position 276 of the polypeptide chain, a serine (S) to threonine (T) substitution at position 375 of the polypeptide chain and a glycine (G) to proline (P) substitution at position 283 of the polypeptide chain. In some exemplary embodiments, the protein sequence of the variant is as set forth in SEQ ID NO: 17.

As exemplified hereinbelow, the combination of these four amino acid substitutions results in an optimized enzyme, where the half-life of activity is increased by 14-fold at 85° C. compared to the wild-type enzyme. Remarkably, no loss of catalytic activity was observed compared to the wild-type endoglucanase.

In some embodiments, a bio-engineered polypeptide variant of Cel8A from C. thermocellum is provided, the variant comprises a glycine (G) to proline (P) substitution at position 283 of the polypeptide chain. In some specific embodiments, the protein sequence of the variant is as set forth in SEQ ID NO: 21.

As exemplified hereinbelow, this single mutation (G283P) displays a higher thermal stability than the wild-type enzyme.

The bio-engineered polypeptide variants of the present invention exhibit increased thermostability compared to the wild-type enzymes from which they are derived.

Thermostability of a protein (for example, an enzyme) may be defined by its melting temperature (Tₘ), namely, the temperature at which 50% of the protein is unfolded. An increased Tₘ corresponds with better thermostability. In some embodiments, the variant cellulases of the present invention have a Tₘ which is at least 4° C., at least 5° C., at least 7° C., at least 9° C. higher than the Tₘ of the unaltered sequence from which they are derived. Each possibility represents a separate embodiment of the invention.

According to another aspect, the present invention provides an isolated polynucleotide encoding a bio-engineered polypeptide variant family-8 cellulase of the present invention.

In some embodiments, the polynucleotide encodes a variant of the endoglucanase Cel8A from C. thermocellum.

In some specific embodiments, the polynucleotide sequence comprises a sequence selected from the group consisting of SEQ ID NO. 7, SEQ ID NO. 11, SEQ ID NO. 15, SEQ ID NO: 19, SEQ ID NO: 23 and SEQ ID NO: 44. Each possibility represents a separate embodiment of the invention.

According to another aspect, the present invention provides an isolated construct comprising a polynucleotide of the present invention.

According to yet another aspect, the present invention provides a genetically-modified cell capable of expressing and producing the variant cellulases of the present invention.

In some embodiments, a genetically-modified cell is provided, comprising a polynucleotide encoding the variant cellulases of the present invention.

In some embodiments, a host cell is provided, comprising a construct comprising a polynucleotide of the present invention.

In some embodiments, the cell is selected from a prokaryotic and eukaryotic cell. Each possibility represents a separate embodiment of the invention. In some specific embodiments, the cell is a prokaryotic cell.

According to another aspect, the present invention provides an artificial cellulosome complex comprising a bio-engineered polypeptide variant of a family-8 cellulase of the present invention.

According to another aspect, the present invention provides a composition comprising a bio-engineered polypeptide variant of a family-8 cellulase of the present invention, for use in the bioconversion process of cellulosic substrates into degradation products.

According to yet another aspect, the present invention provides a method for converting cellulosic material into degradation products, the method comprising exposing said cellulosic material to cells capable of expressing and producing a variant family-8 cellulases of the present invention, for example, the cells described above.

According to yet another aspect, the present invention provides a method for converting cellulosic material into degradation products, the method comprising exposing said cellulosic material to any of the variant polypeptides described above.

These and further aspects and features of the present invention will become apparent from the figures, detailed description, examples and claims which follow.

### BRIEF DESCRIPTION OF THE FIGURES

FIG. 1. Residual activity of Cel8A and H5G2 mutants after heat treatment (82° C., 15 min). Each mutant was generated by site-directed mutagenesis of a single codon in either the wild-type Cel8A or the thermostable mutant H5G2 (mut11-mut14).

FIG. 2. Improvement of residual activity of mutants generated by recombination of selected Cel8A thermostable variants in the first generation library. Wild-type Cel8A (WT) and the S329G (SG) mutant were used as controls. DM1, DM2 and TM were generated as described in the text.

FIG. 3. Thermal inactivation of Cel8A and mutants at 85° C. The residual endoglucanase activity of wild-type (closed circles), SG (open circles), DM1 (closed triangles) and TM (open triangles) was assayed at different time points.

FIG. 4. Schematic ribbon diagram of the overall three dimensional structure of Cel8A (PDB code 1CEM). The residues that were mutated in the thermal resistant variants are marked in white. The residues involved in catalysis are marked in black.

FIG. 5. Protein sequence of Cel8A from C. thermocellum. Consensus mutations are indicated.

FIG. 6. Distribution of consensus mutations in the shuffled library. Several isolates contained between 1-2 additional missense mutations that were not included in the analysis.

FIG. 7. Frequency of mutations in thermostable mutants. Ten of the most stable mutants were sequenced and mapped.

FIG. 8. Kinetics of thermal inactivation of Cel8A variants. The residual activities were measured at different time points. Wild-type Cel8A served as a control. The activity of unheated enzymes was taken as 100%. Each point represents the mean of duplicate determinations.

FIG. 9. Specific activities of wild-type Cel8A and thermostable mutants on CMC and PASC. Enzymes were incubated with 0.5% (wt/vol) solutions at 65° C. for 1 h.

FIG. 10. Schematic ribbon diagram of the overall three dimensional structure of Cel8A (PDB code 1CEM). The localization of the residues that were replaced in the QM mutant in the Cel8A structure is shown.

### DETAILED DESCRIPTION OF THE INVENTION

The present invention provides variant forms of cellulases having a catalytic domain belonging to glycoside hydrolases family-8. In some embodiments, derivatives of the endocellulase Cel8A from C. thermocellum are provided. The variant cellulases of the present invention comprise one or more amino acid substitutions introduced into their catalytic domain, and exhibit enhanced thermostability relative to the wild-type enzyme. According to some aspects, thermostability is enhanced while maintaining high specific activity towards the substrate.

Definitions

As used herein, the term “family-8 cellulase” refers to a cellulase having a catalytic domain classified as family-8 glycoside hydrolase, as defined in the Carbohydrate-Active Enzymes (CAZy) server (www.cazy.org) and/or CAZypedia (www.cazypedia.org).

The terms “catalytic domain” and “catalytic module” are used interchangeably, and as used herein refer to their accepted interpretation for modular enzymes, for which the catalytic domain can be readily identified within the enzyme polypeptide sequence. Such modular enzymes are under the scope of the present invention.

As used herein, the terms “Cel8A”, “endoglucanase Cel8A”, “C. thermocellum Cel8A” are used interchangeably and refer to the endoglucanase Cel8A of C. thermocellum Accession No. AAA83521.

As used herein, the terms “derivative”, “mutant”, “variant” are used interchangeably and refer to a polypeptide which differs from an unaltered, wild-type amino acid sequence due to one or more amino acid substitutions introduced into the sequence, and/or due to the inclusion of sequences not included in the wild-type protein.

As used herein, the terms “wild type” and “unaltered sequence” are used interchangeably and refer to the naturally occurring DNA/protein.

As used herein, the term “gene” has its meaning as understood in the art. In general, a gene is taken to include gene regulatory sequences (e.g. promoters, enhancers, etc.) and/or intron sequences, in addition to coding sequences (open reading frames).

As used herein, the term “isolated” means 1) separated from at least some of the components with which it is usually associated in nature; 2) prepared or purified by a process that involves the hand of man; and/or 3) not occurring in nature.

The terms “polypeptide,” “peptide” and “protein” are used interchangeably herein to refer to a polymer of amino acid residues.

As used herein, the term “DNA construct” refers to an artificially assembled or isolated nucleic acid molecule which comprises the gene of interest.

As used herein, the term “vector” refers to any recombinant polynucleotide construct that may be used for the purpose of transformation, i.e. the introduction of heterologous DNA into a host cell. One exemplary type of vector is a “plasmid” which refers to a circular double stranded DNA loop into which additional DNA segments can be ligated. Another exemplary type of vector is a viral vector, wherein additional DNA segments can be ligated into the viral genome. Certain vectors are capable of autonomous replication in a host cell into which they are introduced.

As used herein, a “primer” defines an oligonucleotide which is capable of annealing to (hybridizing with) a target sequence, thereby creating a double stranded region which can serve as an initiation point for DNA synthesis under suitable conditions.

As used herein, the terms “transformation” refers to the introduction of foreign DNA into cells. The terms “transformants” or “transformed cells” include the primary transformed cell and cultures derived from that cell regardless to the number of transfers. All progeny may not be precisely identical in DNA content, due to deliberate or inadvertent mutations. Mutant progeny that have the same functionality as screened for in the originally transformed cell are included in the definition of transformants.

As used herein, the terms “thermal stability”, “thermostability”, “thermal resistance”, are used interchangeably and refer to the ability of an enzyme to retain activity after exposure to elevated temperatures.

As used herein, the term “enhanced thermostability”, when referring to a variant, indicates an enhanced ability of the variant to retain activity after exposure to elevated temperatures compared to the corresponding wild-type enzyme.

### Amino Acid Substitutions

The present invention discloses several amino acid substitutions in the catalytic domain of family-8 cellulases that confer enhanced thermostability. The position of each of the disclosed mutations is determined herein according to its position in Cel8A, i.e., the amino acid numbering of Cel8A is used as the basis for determining the position of the amino acid substitutions of the present invention. The amino acid sequence of a wild-type family-8 cellulase to be modified is aligned with the amino acid sequence of the wild-type Cel8A in order to determine the position of a particular amino acid substitution of the present invention.

The present invention is based in part on the development of highly thermostable derivatives of Cel8A using two approaches, in-vitro directed evolution and limited mutagenesis in residues that occur in consensus sequences.

As exemplified hereinbelow, random mutagenesis of the gene encoding Cel8A was performed using error-prone PCR followed by DNA shuffling and activity screening. In addition, a bioinformatic-based approach was employed, involving sequence alignment of homologous family-8 glycoside hydrolases, to create a library of consensus mutations in which residues of the catalytic module are replaced at specific positions with the most prevalent amino acids at these positions among the homologous family members. In both approaches, selection procedures favoring recovery of highly thermostable mutants were employed. In order to ensure that thermostability would not compromise enzyme activity, a two-step screening strategy was employed that involved consecutive activity and thermostability assays

Error-prone PCR mutagenesis was used to generate a wide range of random mutations. Next, a two-step screening procedure involving an activity screen followed by a thermostability screen was used in order to isolate thermostable mutants that maintain high activity levels. One of the mutants isolated in the screen for thermostability conferred a remarkable residual activity after heat treatment. This mutant contained four amino acid changes, three of which were expendable for the enzyme properties as demonstrated by site-directed mutagenesis analysis of each of the mutations individually and in combination (Example 2 hereinbelow). The fourth amino acid substitution, a substitution of serine to glycine at position 329 of Cel8A, resulted in a significant increase in thermostability. Thus, the present invention discloses a single replacement in the catalytic domain of family-8 cellulases, such as Cel8A, that is sufficient to provide a significant increase in thermostability.

Increased thermostability upon substitution of a hydrophilic residue with a nonpolar side chain on solvent-exposed protein surfaces is not without precedence (Kotzia et al., Febs J 2009, 276, 1750). Yet, saturation mutagenesis of the S329 site of Cel8A followed by thermostability screening demonstrated that no other amino acid except glycine could confer thermostability at that position. Glycine is the simplest of all amino acids and the lack of a β-carbon enables rotation around both φ and ψ with much less restriction. Several studies have shown that mutations to glycine at specific positions could increase the conformational stability of proteins by alleviating conformational strain and removal of unfavorable steric interactions in the native state such as in left-handed helices (Haruki et al., Febs J 2007, 274, 5815). Nevertheless, in many cases the unique properties of glycine impose an entropic penalty on the protein backbone for folding, and thus cause a reduction in stability. In these studies, substituting glycine by alanine was shown to stabilize proteins at different sites (Hecht et al., Proteins 1986, 1, 43. It is therefore surprising that substituting a serine with a glycine residue in the surface loop position of Cel8A results in such an increase in thermal resistance. Without wishing to be bound to a specific mechanism, it is possible that this surface loop plays an important role in the stability and function of this enzyme.

The present invention further discloses a second amino acid substitution, a non-native arginine (R) at the position corresponding to position 276 of Cel8A (K276R in the case of Cel8A), derived from several thermostable mutants identified in a second random mutagenesis screen (Example 3 hereinbelow). As exemplified hereinbelow, compared to the S329G substitution described above, the K276R conferred a more modest but significant increase in residual activity. The K276 site is located in close tertiary proximity to 5329, and borders the active-site cleft. Although considered a rather conservative substitution, lysine to arginine mutations were shown to confer intrinsic stability to a number of unrelated enzymes. Several studies based on analysis of high-resolution X-ray structures of xylose isomerase enzymes showed that in nearly all cases of improved stability an arginine side chain forms at least one additional H-bond with another polar group in the protein (Mrabet et al., Biochemistry 1992, 31, 2239). Other experimental evidence for the stabilizing effects of the Lys to Arg substitution has been reported for glyceraldehyde-3-phosphate dehydrogenase and human Cu,Zn superoxide dismutase (Mrabet et al., Biochemistry 1992, 31, 2239; and Folcarelli et al, Protein Eng 1996, 9, 323). However, since the structure—function relationship is not known or fully understood for the majority of proteins, and since there is no unique paradigm of thermostable structures, it is not guaranteed that a certain strategy used to increase thermostability of one protein would yield similar results in another protein. The increase in thermostability observed for the mutants of the present invention is therefore unexpected.

The present invention further discloses a third amino acid substitution, a non-native threonine at position 375 (S375T in the case of Cel8A), which was also identified in the second random mutagenesis screen (Example 3 hereinbelow). The S375T substitution showed an additive effect on residual activity. This conservative substitution, which is located in the midst of an a helix of Cel8A, may reflect improved internal packing of the protein. Interestingly, sequence comparison of family 8 cellulases suggests that threonine is the most prevalent amino acid at position 375. Therefore the S375T substitution could be considered a type of ‘back-to-consensus’ mutation. The reversion of protein residues that diverge from the consensus amino acid has been shown in several cases to increase protein stability and solubility (Bershtein et al., J Mol Biol 2008, 379, 1029; and Lehmann et al., Protein Eng 2000, 13, 49). Indeed, this substitution is able to restore the catalytic efficiency and activity that are reduced in a S329G single mutant and a S329G/K276R double mutant. As exemplified hereinbelow, a triple mutant which contains the optimal combination of the three effective substitutions, exhibits high increase in thermal stability, compared to the parental wild-type enzyme, and near wild-type levels of activity on both soluble and insoluble cellulose substrates.

Limited mutagenesis in residues that occur in consensus sequences was performed in order to identify additional mutations that may enhance the intrinsic thermostability of C. thermocellum Cel8A endoglucanase. Although Cel8A is already considered a thermostable enzyme, the sequences used for the multiple alignment contained family 8 endoglucanases from both thermophilic and mesophilic bacteria. Thus, amino acids which are critical for thermostability may be found in mesostable proteins and may be used to further enhance the thermostability of an already thermostable protein. The results demonstrate the utility of the ‘consensus approach’ as a viable tool for enhancement of the thermostability characteristics of an innately thermostable endoglucanase. Out of eight (8) consensus residues, one (G283P) was demonstrated to have a beneficial contribution to the thermostability of Cel8A. The other seven mutations proved either as neutral or deleterious. Thus, the present invention discloses an additional single substitution in the catalytic domain of family-8 cellulases, a non-native proline (P) at the position corresponding to position 283 of Cel8A (G283P in the case of Cel8A), that is sufficient to provide a significant increase in thermostability.

Several studies have shown that applying this strategy frequently leads to the creation of thermostable protein variants. A possible explanation for the stabilizing effect of consensus mutations based on analogy with statistical thermodynamics has been proposed by Steipe et al (J Mol Biol, 1994, 240(3): p. 188-92). However, it was also shown that only some of the consensus mutations contribute to protein stability while others destabilize the protein or are neutral (see, for example, Lehmann et al., Protein Eng, 2002, 15(5): p. 403-11).

The present invention further discloses a quadruple-mutant, which contains the optimal combination of the four substitutions disclosed herein. As exemplified hereinbelow for Cel8A, the quadruple-mutant exhibits an increase in thermal stability, compared to the parental wild-type enzyme. Remarkably, no loss of catalytic activity was observed compared to the wild-type endoglucanase.

The consensus method may not always indicate the most stabilizing amino acid at a specific position, and a library of single mutations or combination of mutations will often be necessary. Introducing the G283P mutation to increase the thermostability of the triple mutant (TM) generated by a random library resulted in a further enhanced thermostable protein.

The conformation of proteins is maintained by a large number of weak interactions. The free energy change of unfolding for most proteins is marginal, and the additional stabilizing energy required to achieve the properties of highly stable proteins is of the same order of magnitude, equivalent to only a few weak interactions (Daniel et al., Biochem J 1996, 317 (Pt]), 1. Data presented in the present invention demonstrate that a few point mutations are sufficient to drastically increase the natural high resistance of this enzyme toward thermal inactivation without compromising activity and that even in the case of an enzyme such as C. thermocellum Cel8A that is naturally highly thermostable, there is opportunity for substantial improvement.

### Thermostable Cellulases

According to one aspect, the present invention provides isolated variants of family-8 cellulases comprising at least one non-native amino acid substitution artificially introduced into the catalytic domain of the enzyme, wherein the polypeptide variant has an enhanced thermostability compared to the corresponding wild-type sequence.

In some embodiments, the variant comprises a non-native glycine (G) at the position corresponding to position 329 of C. thermocellum Cel8A, said position being determined from sequence alignment of the unaltered sequence with the amino acid sequence of C. thermocellum Cel8A set forth in SEQ ID NO: 1. Methods for sequence alignment are known in the art and include, for example, the use of web-based servers such as ClustalW, www.ebi.ac.uk/Tools/msa/clustalw2.

In some embodiments, the variant comprises a non-native glycine (G) at the position corresponding to position 329 of C. thermocellum Cel8A and further comprising an additional substitution selected from the group consisting of a non-native arginine (R) at the position corresponding to position 276 of C. thermocellum Cel8A, and non-native threonine (T) at the position corresponding to position 375 of C. thermocellum Cel8A. Each possibility represents a separate embodiment of the invention.

In some embodiments, the variant comprises a non-native glycine (G) at the position corresponding to position 329 of C. thermocellum Cel8A, a non-native arginine (R) at the position corresponding to position 276 of C. thermocellum Cel8A, and a non-native threonine (T) at the position corresponding to position 375 of C. thermocellum Cel8A.

In some embodiments, the variant comprises a non-native glycine (G) at the position corresponding to position 329 of C. thermocellum Cel8A, a non-native arginine (R) at the position corresponding to position 276 of C. thermocellum Cel8A, a non-native threonine (T) at the position corresponding to position 375 of C. thermocellum Cel8A., and a non-native proline (P) at the position corresponding to position 283 of C. thermocellum Cel8A.

In some embodiments, the at least one amino acid substitution is a non-native proline (P) at the position corresponding to position 283 of C. thermocellum Cel8A.

In some embodiments, a variant polypeptide of a family-8 cellulase is provided, the variant comprises either a non-native glycine (G) at the position corresponding to position 329 of C. thermocellum Cel8A, a non-native arginine (R) at the position corresponding to position 276 of C. thermocellum Cel8A, a non-native threonine (T) at the position corresponding to position 375 of C. thermocellum Cel8A., a non-native proline (P) at the position corresponding to position 283 of C. thermocellum Cel8A or any combination thereof.

In some embodiments, variants of the endoglucanase Cel8A from C. thermocellum are provided.

In some embodiments, the Cel8A variant comprises at least one mutation selected from the group consisting of S329G, K276R, S375T and G283P. Each possibility represents a separate embodiment of the invention. In some specific embodiments, the variants of the present invention comprise a Cel8A single mutant, double mutant, triple mutant and/or quadruple mutant.

In some embodiments, the variant Cel8A comprises a serine (S) to glycine (G) substitution at position 329 of the polypeptide chain. An exemplary Cel8A variant comprising said substitution is provided in SEQ ID NO: 5. A corresponding DNA sequence encoding the variant is provided in SEQ ID NO: 7.

In other embodiments, the variant Cel8A comprises a glycine (G) to proline (P) at position 283 of the polypeptide chain. An exemplary Cel8A variant comprising said substitution is provided in SEQ ID NO: 21. corresponding DNA sequence encoding the variant is provided in SEQ ID NO: 23.

In some embodiments, the variant Cel8A comprises a serine (S) to glycine (G) substitution at position 329 of the polypeptide chain and a lysine (K) to arginine (R) substitution at position 276 of the polypeptide chain. An exemplary Cel8A variant comprising said substitutions is provided in SEQ ID NO: 9. A corresponding DNA sequence encoding the variant is provided in SEQ ID NO: 11.

In some embodiments, the variant Cel8A comprises a serine (S) to glycine (G) substitution at position 329 of the polypeptide chain and a serine (S) to threonine (T) substitution at position 375 of the polypeptide chain. An exemplary Cel8A variant comprising said substitutions is provided in SEQ ID NO: 43. A corresponding DNA sequence encoding the variant is provided in SEQ ID NO: 44.

In some embodiments, the variant Cel8A comprises a serine (S) to glycine (G) substitution at position 329 of the polypeptide chain, a lysine (K) to arginine (R) substitution at position 276 of the polypeptide chain and a serine (S) to threonine (T) substitution at position 375 of the polypeptide chain. An exemplary Cel8A variant comprising said substitutions is provided in SEQ ID NO: 13. A corresponding DNA sequence encoding the variant is provided in SEQ ID NO: 15.

In some embodiments, the variant Cel8A comprises a serine (S) to glycine (G) substitution at position 329 of the polypeptide chain, a lysine (K) to arginine (R) substitution at position 276 of the polypeptide chain, a serine (S) to threonine (T) substitution at position 375 of the polypeptide chain, and a glycine (G) to proline (P) substitution at position 283 of the polypeptide chain. An exemplary Cel8A variant comprising said substitutions is provided in SEQ ID NO: 17. A corresponding DNA sequence encoding the variant is provided in SEQ ID NO: 19.

Protein thermostability may be defined, for example, by its melting temperature (Tₘ), the half-life (t_{1/2}) at a defined temperature, and the temperature at which 50% of the initial enzyme activity is lost after incubation at a defined time (T₅₀).

In some embodiments, the variant cellulases of the present invention has a Tₘ which is at least about 4° C., at least about 5° C., at least about 7° C., at least about 9° C. higher than the Tₘ of the unaltered sequence from which they are derived. Each possibility represents a separate embodiment of the invention. The Tₘ may be determined, for example, using circular dichroism, as exemplified below.

The variant polypeptides disclosed herein may be produced by either recombinant or chemical synthetic methods. In some currently preferred embodiments, the variant family-8 cellulases are a product of recombinant expression.

Recombinant Expression

The variant polypeptides of the present invention may be synthesized by expressing a polynucleotide molecule encoding the variant polypeptide in a host cell, for example, a microorganism cell transformed with the nucleic acid molecule. Such a polynucleotide may be produced, for example, by mutation of a first polynucleotide encoding a wild type polypeptide, so as to provide a second polynucleotide which encodes a variant polypeptide having replacements of one or more residues which are normally present in the wild type cellulase.

DNA sequences encoding wild type family-8 cellulases may be isolated from any strain or subtype of a microorganism producing them, using various methods well known in the art (see for example, Sambrook, et al., Molecular Cloning: A Laboratory Manual, Third Edition, Cold Spring Harbor, N.Y., (2001)). For example, a DNA encoding the wild-type polypeptide may be amplified from genomic DNA of the appropriate microorganism by polymerase chain reaction (PCR) using specific primers, constructed on the basis of the nucleotide sequence of the known wild type sequence. Suitable techniques are well known in the art, described for example in U.S. Pat. Nos. 4,683,195; 4,683,202; 4,800,159 and 4,965,188

The genomic DNA may be extracted from the bacterial cell prior to the amplification using various methods known in the art, see for example, Marek P. M et al., “Cloning and expression in Escherichia coli of Clostridium thermocellum DNA encoding p-glucosidase activity”, Enzyme and Microbial Technology Volume 9, Issue 8, August 1987, Pages 474-478.

The isolated polynucleotide encoding the wild type family-8 cellulase may be cloned into a vector, such as the pET28a plasmid.

Upon isolation and cloning of the polynucleotide encoding a wild type family-8 cellulase, the desired mutation(s) may be introduced by modification at one or more base pairs, using methods known in the art, such as for example, site-specific mutagenesis (see for example, Kunkel Proc. Natl. Acad. Sci. USA 1985, 82:488-492; Weiner et al., Gene 1994, 151:119-123; Ishii et al., Methods Enzymol. 1998, 293:53-71); cassette mutagenesis (see for example, Kegler-Ebo et al., Nucleic Acids Res. 1994 May 11; 22(9):1593-1599); recursive ensemble mutagenesis (see for example, Delagrave et al., Protein Engineering 1993, 6(3):327-331), and gene site saturation mutagenesis (see for example, U.S. Pat. Application No. 2009/0130718).

Methods are also well known for introducing multiple mutations into a polynucleotide (see for example, Michaelian et al., Nucleic Acids Res. 1992, 20:376; Dwivedi et al., Anal. Biochem. 1994, 221:425-428; Bhat Methods Mol. Biol. 1996, 57:269-277; Meetei et al., Anal. Biochem. 1998, 264:288-291; Kim et al., Biotechniques 2000, 28:196-198; and International patent Application Publication Nos. WO 03/002761A1 and WO 99/25871).

For example, introduction of two and/or three mutations can be performed using commercially available kits, such as the QuickChange® site-directed mutagenesis kit (Stratagene).

An alternative method to producing a polynucleotide with a desired sequence is the use of a synthetic gene. A polynucleotide encoding a variant of family-8 cellulase may be prepared synthetically, for example using the phosphoroamidite method (see, Beaucage et al., Curr Protoc Nucleic Acid Chem. 2001 May; Chapter 3:Unit 3.3; Caruthers et al., Methods Enzymol.1987, 154:287-313).

The use of synthetic genes allows production of an artificial gene which comprises an optimized sequence of nucleotides to be expressed in desired species (for example, E. coli). Redesigning a gene offers a means to improve gene expression in many cases. Rewriting the open reading frame is possible because of the redundancy of the genetic code. Thus, it is possible to change up to about a third of the nucleotides in an open reading frame and still produce the same protein. For example, for a typical protein sequence of 300 amino acids there are over 10¹⁵° codon combinations that will encode an identical protein. Using optimization methods such as replacing rarely used codons with more common codons can result in dramatic effect on levels of expression of protein encoded by the target gene. Further optimizations, such as removing RNA secondary structures, can also be included. Computer programs are available to perform these and other simultaneous optimizations. Because of the large number of nucleotide changes made to the original DNA sequence, the only practical way to create the newly designed genes is to use gene synthesis.

The polynucleotide thus produced, which encodes a variant of a family-8 cellulase, may then be subjected to further manipulations, including one or more of purification, annealing, ligation, amplification, digestion by restriction endonucleases and cloning into appropriate vectors. The polynucleotide may be ligated either initially into a cloning vector, or directly into an expression vector that is appropriate for its expression in a particular host cell type.

Polypeptides of the invention may also be produced as fusion proteins, for example to aid in extraction and purification. It may also be convenient to include a proteolytic cleavage site between the fusion protein partner and the protein sequence of interest to allow removal of fusion protein sequences, such as a thrombin cleavage site.

The polynucleotide encoding the polypeptide of the invention may be incorporated into a wide variety of expression vectors, which may be transformed into in a wide variety of host cells. The host cell may be prokaryotic or eukaryotic.

Introduction of a polynucleotide into the host cell can be effected by well known methods, such as chemical transformation (e.g. calcium chloride treatment), electroporation, conjugation, transduction, calcium phosphate transfection, DEAE-dextran mediated transfection, transvection, microinjection, cationic lipid-mediated transfection, scrape loading, ballistic introduction and infection.

Representative examples of appropriate hosts include bacterial cells, such as cells of E. coli and Bacillus subtilis.

The polypeptides may be expressed in any vector suitable for expression. The appropriate vector is determined according the selected host cell. Vectors for expressing proteins in E. coli, for example, include, but are not limited to, pET, pK233, pT7 and lambda pSKF. Other expression vector systems are based on beta-galactosidase (pEX); maltose binding protein (pMAL); and glutathione S-transferase (pGST).

The proteins may be designed to include a tag. A non-limiting example of a fusion construct is His-Tag (six consecutive histidine residues), which can be isolated and purified by conventional methods.

Selection of a host cell transformed with the desired vector may be accomplished using standard selection protocols involving growth in a selection medium which is toxic to non-transformed cells. For example, E. coli may be grown in a medium containing an antibiotic selection agent; cells transformed with the expression vector which further provides an antibiotic resistance gene, will grow in the selection medium.

Upon transformation of a suitable host cell, and propagation under conditions appropriate for protein expression, the desired polypeptide ma y be identified in cell extracts of the transformed cells. Transformed hosts expressing a variant family-8 cellulase may be identified by analyzing the proteins expressed by the host using SDS-PAGE and comparing the gel to an SDS-PAGE gel obtained from the host which was transformed with the same vector but not containing a nucleic acid sequence encoding a family-8 cellulase or a variant of a family-8 cellulase.

Variant family-8 cellulases can also be identified by other known methods such as immunoblot analysis using anti-family-8 cellulase antibodies, dot blotting of total cell extracts, limited proteolysis, mass spectrometry analysis, and combinations thereof.

Variant family-8 cellulases which have been identified in cell extracts may be isolated and purified by conventional methods, including ammonium sulfate or ethanol precipitation, acid extraction, salt fractionation, ion exchange chromatography, hydrophobic interaction chromatography, gel permeation chromatography, affinity chromatography, and combinations thereof.

In particular embodiments, the polypeptides of the invention can be produced as fusion proteins, attached to an affinity purification tag, such as a His-tag, in order to facilitate their rapid purification.

The isolated variant of the family-8 cellulase can be analyzed for its various properties, for example specific activity and thermal stability, using methods known in the art, some of them are described hereinbelow.

Conditions for carrying out the aforementioned procedures as well as other useful methods are readily determined by those of ordinary skill in the art (see for example, Current Protocols in Protein Science, 1995 John Wiley & Sons).

In particular embodiments, the polypeptides of the invention can be produced and/or used without their start codon (methionine or valine) and/or without their leader (signal) peptide to favor production and purification of recombinant polypeptides. It is known that cloning genes without sequences encoding leader peptides will restrict the polypeptides to the cytoplasm of the host cell and will facilitate their recovery (see for example, Glick, B. R. and Pasternak, J. J. (1998) In “Molecular biotechnology: Principles and applications of recombinant DNA”, 2nd edition, ASM Press, Washington D.C., p. 109-143).

Synthetic Production

The variant polypeptides of the present invention may also be produced by synthetic means using well known techniques, for example, solid phase synthesis (see for example, Merrifield, R. B., J. Am. Chem. Soc., 85:2149-2154, 1963; Stewart, J. M. and Young, J. D., Solid Phase Peptide Synthesis, 2nd Ed., Pierce Chemical Co., Rockford, Ill., pp. 11-12). Synthetic peptides may be produced using commercially available laboratory peptide design and synthesis kits (see for example, Geysen et al, Proc. Natl. Acad. Sci., USA 1984, 81:3998). In addition, a number of available FMOC peptide synthesis systems are available. Assembly of a polypeptide or fragment can be carried out on a solid support using for example, an Applied Biosystems, Inc. Model 431A automated peptide synthesizer. The polypeptides may be made by either direct synthesis or by synthesis of a series of fragments that can be coupled using other known techniques.

Polynucleotides, Constructs and Host Cells

According to another aspect, the present invention provides a nucleic acid molecule encoding a bio-engineered variant of a family-8 cellulase, the variant comprising at least one amino acid substitution introduced into the catalytic domain of the enzyme and having an enhanced thermostability compared to the unaltered sequence.

In some embodiments, the polynucleotide encodes a variant of the endoglucanase Cel8A from C. thermocellum.

In some embodiments, the polynucleotide sequence encodes a variant Cel8A polypeptide comprising at least one amino acid substitution selected from the group consisting of S329G, K276R, S375T and G283P. Each possibility represents a separate embodiment of the invention.

In some embodiments, the present invention provides polynucleotide sequences encoding the disclosed variants of family-8 cellulases. In some specific embodiments, the polynucleotides encode the disclosed Cel8A variants.

As is readily apparent to those of skill in the art, the codon used in the polynucleotide for encoding a particular amino acid which is to substitute an amino acid originally present in the sequence encoding the wild-type enzyme, should be selected in accordance with the known and favored codon usage of the host cell which was selected for expressing the polynucleotide.

A skilled person will be aware of the relationship between nucleic acid sequence and polypeptide sequence, in particular, the genetic code and the degeneracy of this code, and will be able to construct nucleic acids encoding the polypeptides of the present invention without difficulty. For example, a skilled person will be aware that for each amino acid substitution in a polypeptide sequence, there may be one or more codons which encode the substitute amino acid. Accordingly, it will be evident that, depending on the degeneracy of the genetic code with respect to that particular amino acid residue, one or more nucleic acid sequences may be generated corresponding to a certain variant polypeptide sequence. Furthermore, where the variant polypeptide comprises more than one substitution, for example S329G/K276R in a Cel8A variant, the corresponding nucleic acids may comprise pairwise combinations of the codons which encode respectively the two amino acid changes.

The polynucleotides of the present invention may include non-coding sequences, including for example, non-coding 5′ and 3′ sequences, such as transcribed, non-translated sequences, termination signals, ribosome binding sites, sequences that stabilize mRNA, introns and polyadenylation signals. Further included are polynucleotides that comprise coding sequences for additional amino acids heterologous to the variant polypeptide, in particular a marker sequence, such as a poly-His tag, that facilitates purification of the polypeptide in the form of a fusion protein.

According to another aspect, the present invention provides a construct comprising a polynucleotide of the present invention.

According to yet another aspect, the present invention provides a genetically-modified cell capable of expressing and producing the variant cellulases of the present invention. In some embodiments, the cell comprises the construct described above.

In some embodiments, the variant cellulase is designed to include a signal sequence in order to enable its secretion from the host cell. According to these embodiments, a genetically-modified cell is provided, said cell is capable of producing and secreting the variant polypeptide of the present invention.

In some embodiments, the cell is a prokaryotic cell. Representative, non-limiting examples of appropriate prokaryotic hosts include bacterial cells, such as cells of Escherictahia coli and Bacillus subtilis. In other embodiments, the cell is a eukaryotic cell. In some exemplary embodiments, the cell is a fungal cell, such as yeast. Representative, non-limiting examples of appropriate yeast cells include Saccharomyces cerevisiae and Pichia pastoris. In additional exemplary embodiments, the cell is a plant cell.

Methods and Uses

The variant polypeptides of the present invention, compositions comprising same and cells producing same may be utilized for the bioconversion of cellulosic material into degradation products

The term “cellulosic substrate” encompasses any substrate derived from plant biomass and comprising cellulose, including but not limited to, lignocellulosic feedstocks for the production of ethanol or other high value products, animal feeds, forestry waste products, such as pulp and wood chips, and textiles.

Resulting sugars may be used for the production of alcohols such as ethanol, propanol, butanol and/or methanol, production of fuels, e.g., biofuels such as synthetic liquids or gases, such as syngas, and the production of other fermentation products, e.g. succinic acid, lactic acid, or acetic acid.

The variant polypeptides of the present invention may also be incorporated into artificial cellulosome complexes, also referred to as designer cellulosomes.

The designer cellulosome concept is based on the very high affinity and specific interaction between cohesin and dockerin modules from the same microorganism species. Designer cellulosomes are typically constructed from recombinant chimeric scaffoldins containing divergent cohesins from different microorganism species to which matching dockerin-containing enzyme hybrids are prepared. In effect, in designer cellulosomes, enzymes are complexed together on a scaffoldin subunit via the very strong and specific cohesin-dockerin interaction.

Thus, according to another aspect, the present invention provides an artificial cellulosome complex comprising a bio-engineered polypeptide variant of a family-8 cellulase of the present invention.

According to another aspect, the present invention provides a composition comprising an isolated polypeptide variant of a family-8 cellulase of the present invention, for use in the bioconversion process of cellulosic substrates into degradation products.

According to yet another aspect, the present invention provides a method for converting cellulosic material into degradation products, the method comprising exposing said cellulosic material to cells capable of expressing a variant family-8 cellulases of the present invention, for example, the host cells described above.

According to yet another aspect, the present invention provides a method for converting cellulosic material into degradation products, the method comprising exposing said cellulosic material to any of the variant polypeptides described above.

The polypeptides of the present invention may be added to bioconversion and other industrial processes for example, continuously, in batches or by fed-batch methods. Alternatively or additionally, the enzymes of the present invention may be recycled.

By relieving end-product inhibition of endoxylanases and exo/endoglucanases (such as xylobiose and cellobiose), it may be possible to further enhance the hydrolysis of the cellulosic material.

The following examples are presented in order to more fully illustrate certain embodiments of the invention. They should in no way, however, be construed as limiting the broad scope of the invention. One skilled in the art can readily devise many variations and modifications of the principles disclosed herein without departing from the scope of the invention.

### EXAMPLES

### Example 1

### Directed Evolution Construction of Mutant Cel8A Libraries and Screening

### Methods

Plasmids, strains and growth conditions: Cel8A from Clostridium thermocellum ATCC 27405 was cloned without the signal peptide into pET28a (Novagen, Madison, Wis.) with a C-terminal His tag. The amino acid sequence and DNA sequence of the cloned Cel8A are set forth in SEQ ID NOs: 3 and 4, respectively. E. coli DH5α was used for propagation of plasmids. E. coli BL21 (DE3) was used for high level expression of the recombinant endoglucanase, and was cultivated at 37° C. in Luria-Bertani (LB) medium containing 50 μg/ml kanamycin.

Random mutagenesis and construction of libraries: A library of cel8A mutants was generated by error-prone PCR using a GeneMorph II Random Mutagenesis Kit (Stratagene, La Jolla, Calif.). pET28cel8A plasmid was used as a template and T7 promoter primer and T7 terminator primer were used for amplification. Reaction mixtures contained 8 ng of pETcel8A. Thermal cycling parameters were 95° C. for 3 min and 28 cycles of 95° C. for 40 s, 56° C. for 40 s and 72° C. for 1.2 min. The resulting PCR product was treated with DpnI (New England Biolabs, UK) to destroy the template plasmid, purified from agarose gel, and then used as a template for a nested PCR using ReadyMix PCR reaction mix (Thermo Scientific, Waltham, Mass.) and primers 5′-AAGAAGGAGATATACCATGG-3′ (SEQ ID NO: 25) and 5′-GTGGTGGTGGTGCTCGAG-3′ (SEQ ID NO: 26) (boldface letters indicate NcoI and XhoI restriction sites, respectively). The amplified product was purified and ligated into the expression vector pET28a through the restriction sites and transformed into E. coli DH5α cells, yielding ˜10⁵ transformants. Plasmid DNA was then extracted to obtain the library for subsequent transformations and screening.

Screening for thermostable endoglucanase variants: Transformed E. coli cells derived from the library of Cel8A variants were spread onto LB plates containing 50 μg/ml kanamycin and incubated overnight at 37° C. The plates were overlaid with soft agar containing 0.3% CMC, 0.7% agar and 0.2 mM IPTG as an inducer in 25 mM sodium acetate (pH 6.0). The plates were incubated for 30 min at 37° C. to induce enzyme expression and 2 h at 60° C. to facilitate enzyme activity. The plates were then stained for 10 min with 0.25% fresh Congo red solution and destained with 1 M NaCl. The clones that formed large halos around the colonies, which is indicative of their endoglucanase activity, were selected from replica plates, and grown overnight at 37° C. in 96-well plates containing 0.5 ml LB, 50 μg/ml kanamycin and 0.1 mM IPTG. Proteins were extracted using PopCulture Reagent (Novagen) according to the product manual. A sample of the extracted solution was diluted in 50 mM sodium acetate (pH 6.0) and incubated at various temperatures and time periods. Residual activity was determined with 1% CMC, 10 mM CaCl₂ and 50 mM sodium acetate (pH 6.0) at 65° C. The amount of reducing sugars released by the enzyme was determined colorimetrically using 3,5-dinitrosalicylic acid (DNS) reagent (Miller et al., Anal. Biochem 1959, 31, 426).

### Results

In vitro directed evolution was applied on the full-length cel8A gene from C. thermocellum, including its non-catalytic C-terminus dockerin module. The open reading frame (ORF) of the cel8A gene was amplified by error-prone PCR with mutation rates of between 2-7 mutations per kilobase. The resultant library of variant genes was amplified again and cloned into the pET28a expression vector and expressed in E. coli. The diversity of the genes in the resulting library was examined by sequence analysis of 10 randomly selected colonies. In order to screen for thermostable mutant enzymes, a two-step screening strategy was employed. For the initial screening step, identification of active endoglucanase enzymes was performed using a high-throughput screening procedure employing double layered carboxymethyl cellulose (CMC)-containing plates. This assay takes advantage of small leakage of enzyme from the individual colonies which express Cel8A to facilitate the detection of active enzymes.

Using this approach, approximately 9000 colonies were screened for enzyme activity, of which ˜30% showed clearing zones similar in size to the parental clones. Out of these, 2880 clones were selected for the subsequent screening. In the second screen, the retention of endoglucanase activity was measured after heating the samples for 15 min at 82° C. After incubation at this elevated temperature, the wild-type Cel8A enzyme retained only ˜41% of its activity. Thus, any clone that showed a significant level of improvement after the heat treatment was considered a candidate for a thermostable enzyme. Four clones demonstrated significant thermostability compared to wild-type Cel8A enzyme, out of which one (H5G2) showed considerably higher residual activity after heat treatment (Table 1). To avoid artifacts from double transformants and to confirm the thermoresistance of the enzymes, the cultures were streaked onto agar plates, and a few colonies from each were grown and reanalyzed for thermostability. Plasmids were then extracted from the positive clones and retransformed into fresh E. coli cells, in order to confirm the phenotype. The cel8A ORF of the extracted plasmids from the positive clones were sequenced to determine the mutation(s) responsible for the observed thermostability (Table 1).

TABLE 1
Residual activity of the randomly generated mutants

| | Residual | |
|---|---|---|
| | activity^{a} (%) | Amino acid substitutions |
| Cel8A | 41% ± 4.4 | None |
| EG5 | 59% ± 9.0 | N139Y/S375T/K438R |
| H5G2 | 85% ± 3.8 | R311G/S329G/L395I/A448V |
| C1D1 | 55% ± 7.7 | S142C/A225V/M461L |
| F6A5 | 58% ± 1.9 | K276R/N351Y |

^{a}Measured after incubation at 82° C. for 15 min

### Example 2

### A Single Amino-Acid Substitution in Cel8A Confers Enhanced Thermostability

### Methods

Site-directed and saturation mutagenesis: Single point mutations were generated in Cel8A (R311G, S329G, L395I, A448V) and in H5G2 (G311R, G329S, I395L and V448A) using QuickChange site-directed mutagenesis kit (Stratagene). To verify that only the designated mutations were inserted by the Pfu Turbo DNA polymerase, the full Cel8A gene was sequenced.

A gene library encoding all possible amino acids at position S329 of Cel8A was constructed by replacing the target codon with NNS (where N is A, G, C, or T and S is G or C). Two degenerate primers: 5′-CAAGGTTCAAAAATTNNSAACAATCACAACG-3′ (SEQ ID NO: 27) and 5′-CGTTGTGATTGTTSNNAATTTTTGAACCTTG-3′ (SEQ ID NO: 28) (boldface letters indicate the degenerate nucleotides), were designed to randomize position S329 in the nucleotide sequence.

### Results

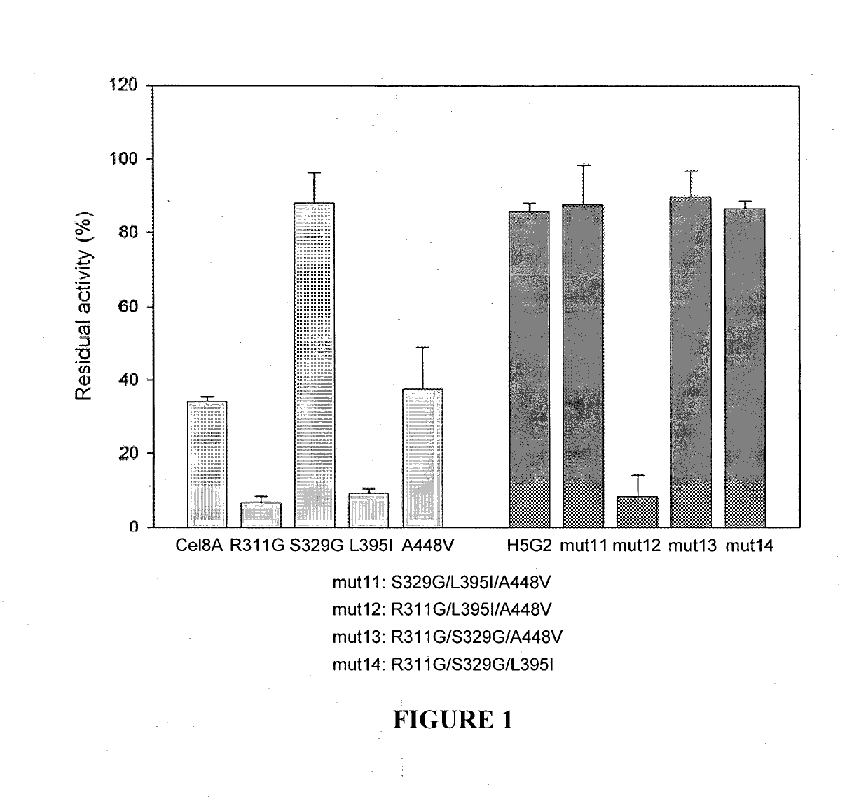

Four amino acid substitutions (R311G, S329G, L395I, A448V) were mapped to the H5G2 clone. In order to determine which amino acid substitutions were responsible for the increased thermostability, a matrix of eight combinations of mutations was performed by site directed mutagenesis on Cel8A and mutant H5G2. The results, presented in FIG. 1, indicated that a single mutation (S329G) was sufficient to produce a thermostable variant. The other three substitutions either diminished the thermostability of the enzyme (R311G and L395I) or did not contribute to its thermostability, as demonstrated by the A448V substitution that occurred in the dockerin module of the protein. The reciprocal mutagenesis performed on H5G2 demonstrated that the mutant containing the three substitutions besides S329G (mut12) exhibited reduced thermostability. Remarkably, the S329G mutation not only conferred significant thermostability but also served to overcome the apparent destructive effects of the R311G and L395I substitutions.

In order to confirm that this variant possesses significantly higher intrinsic thermostability than the wild-type enzyme, the enzymes were purified to homogeneity by virtue of the attached His tag, and the S329G mutant was assayed for increased thermostability (the amino acid sequence and DNA sequence of the His-tagged S329G mutant are set forth in SEQ ID NOs: 6 and 8, respectively. The results indicated clearly that the mutant enzyme is significantly more thermostable than the wild-type enzyme. To determine whether the S329G mutation was the only one which could confer thermostability, saturation mutagenesis was performed at the S329 site. To insure a 0.99 probability of all possible outcomes, the library size for one mutated site was calculated by a binomial probability approximation to be 140 colonies. We screened over 200 clones from the saturation mutagenesis library for Cel8A mutants and assumed to obtain all 19 mutants besides the wild-type. Five clones demonstrated significant residual activity after heat treatment. These clones were isolated and sequenced and were all found to contain the serine to glycine mutation at position 329. This result demonstrated that the mutation was unique in conferring thermostability to the Cel8A enzyme and cannot be optimized further by a different amino acid substitution.

### Example 3

### Optimization of the Cel8A Mutant by Combination of Mutations

### Methods

In vitro DNA recombination: The four mutants that demonstrated a significant increase in thermostability were individually amplified, mixed, and digested with DNase I (Sigma). The resulting 50-200 by fragments were assembled by PCR as described previously (Abecassis et al., Nucleic Acids Res 2000, 28, E88). The resulting library was cloned into the pET28 vector using the NcoI and XhoI restriction sites.

### Results

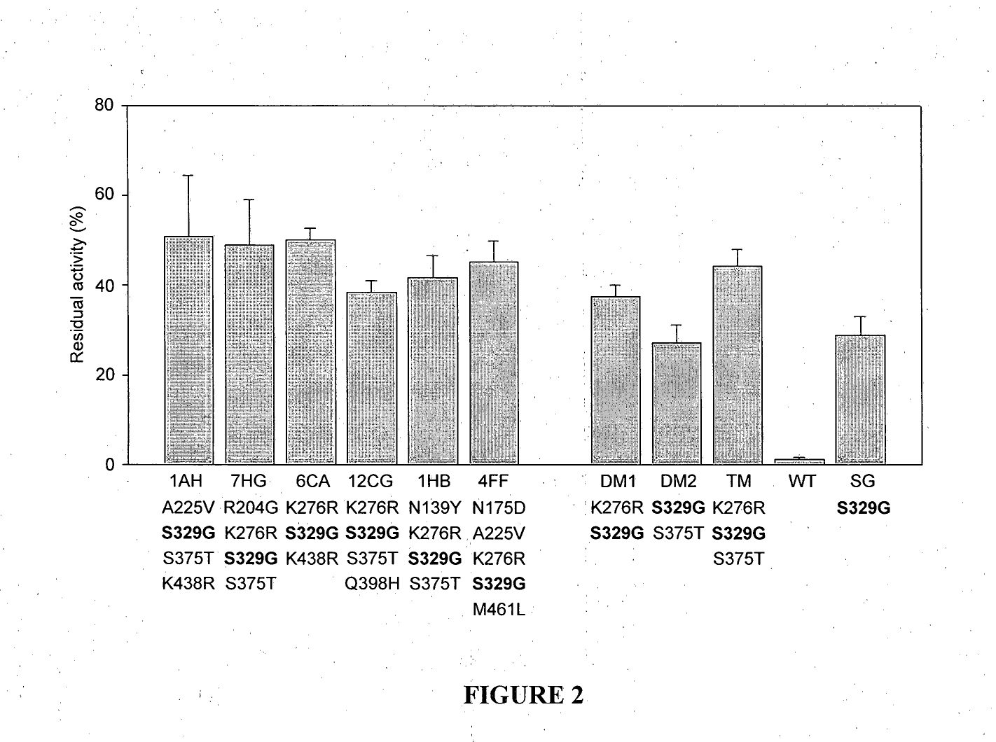

The four clones that showed increased thermostability were shuffled using in-vitro recombination to produce an assembly of different combinations of mutations. The assembled PCR fragments were ligated into pET28a and transformed into E. coli cells. Approximately 1000 colonies were isolated. At this stage, initial CMC plate assay was not required, as over 95% of the colonies were positive for activity at 60° C. The clones were subjected to heat treatment of 15 min at an increased temperature (87° C.). Under these conditions, the S329G mutant retained 30% of its activity while the wild-type enzyme underwent near-complete inactivation. FIG. 2 shows the six variants that were selected for their increased thermostability compared to the S329G mutant. Sequencing analysis revealed that all contained the S329G mutation. Five mutants contained a K276R mutation and four contained a S375T mutation. The presence of these mutations in the majority of thermostable clones prompted us to engineer mutant enzymes that contained a combination of the two mutations DM1 and DM2 (K276R/S329G and S329G/S375T respectively) and three mutations, TM (K276R/S329G/S375T). The amino acid sequences of the His-tagged DM1, DM2 and TM are set forth in SEQ ID NOs: 10, 29 and 14, respectively. The corresponding DNA sequences are set forth in SEQ ID NOs: 12, 30 and 16, respectively.

Mutants DM1 and TM, which showed the highest thermostability, were purified to homogeneity and their thermostability properties were determined and compared with that of the SG single mutant and the wild-type enzyme.

### Example 4

### Enzymatic Characterization of the Evolved Cel8A Mutants

### Methods

Protein expression and purification: For detailed analysis of Cel8A and variants, E. coli BL21 (DE3) transformants were grown at 37° C. in LB supplemented with 50 μg/ml kanamycin, until an OD₆₀₀ of ˜0.8 was reached. Overexpression was induced by adding 0.5 mM IPTG; the cultures were grown for another 3 h and harvested (4000×g, 15 min, 4° C.). The pellet was frozen overnight at −20° C. The cells were resuspended in Tris-buffered saline (TBS, 137 mM NaCl, 2.7 mM KCl, 25 mM Tris-HCl, pH 7.4) supplemented with 5 mM imidazole (Merck KGaA, Darmstadt, Germany) and protease-inhibitor cocktail (1 mM phenylmethylsulfonyl fluoride (PMSF), 0.4 mM benzamidine and 0.06 mM benzamide from Sigma-Aldrich, St. Louis, Mo.) and disrupted by sonication. The sonicate was heated for 30 min at 60° C. then centrifuged (20,000×g, 30 min, 4° C.). The soluble fraction was mixed with Ni-NTA (nitrilotriacetic acid), supplemented with 5-10 mM imidazole, for 1 h in an Econo-pack column at 4° C. (batch purification system). The column was then washed by gravity flow with 50 mM imidazole. Elution was preformed first using 100 mM imidazole, followed by 250 mM imidazole. Fractions (2 ml) were collected and analyzed by SDS-PAGE. The fractions containing the purified proteins were pooled and extensively dialyzed against 50 mM sodium acetate buffer at pH 6.0. Protein concentrations were determined by spectrophotometeric absorbance (280 nm) using the calculated molar absorption coefficient of the protein. Samples were stored at 4° C., supplemented with 0.02% sodium azide, or at -20° C. with 50% glycerol.

Circular dichroism (CD) measurements: Melting curves were recorded on a Chirascan circular dichroism spectrometer (Applied Photophysics, Surrey, UK) in a 1-mm path-length cuvette. The proteins were used at ˜5 μM concentration in 50 mM sodium acetate buffer at pH 6.0., the samples were heated at a rate of 1° C./ min from 55 to 95° C., and the CD ellipticity signal at 222 nm, which showed the maximal change with the temperature, was monitored.

Enzyme assays and kinetics: Endoglucanase activity was measured by incubating the purified enzymes with 0.5% (wt/vol) of CMC or phosphoric acid-swollen cellulose (PASC) at 65° C. for 1 h with occasional shaking. Activities were determined by assaying the release of reducing sugars by the DNS method. Enzyme activity was expressed as units (U). One unit of endoglucanase activity corresponds to the release of 1 μMol of glucose equivalent per hour. Kinetic parameters for endoglucanase activity were determined using substrate concentrations ranging from 2 to 20 g/l CMC. Due to limited substrate solubility, data were fitted to the linear regime of the Michaelis-Menten model [v₀=[S]₀[E]₀k_{cat}/Kₘ] and k_{cat}/Kₘ was deduced from the slope.

### Results

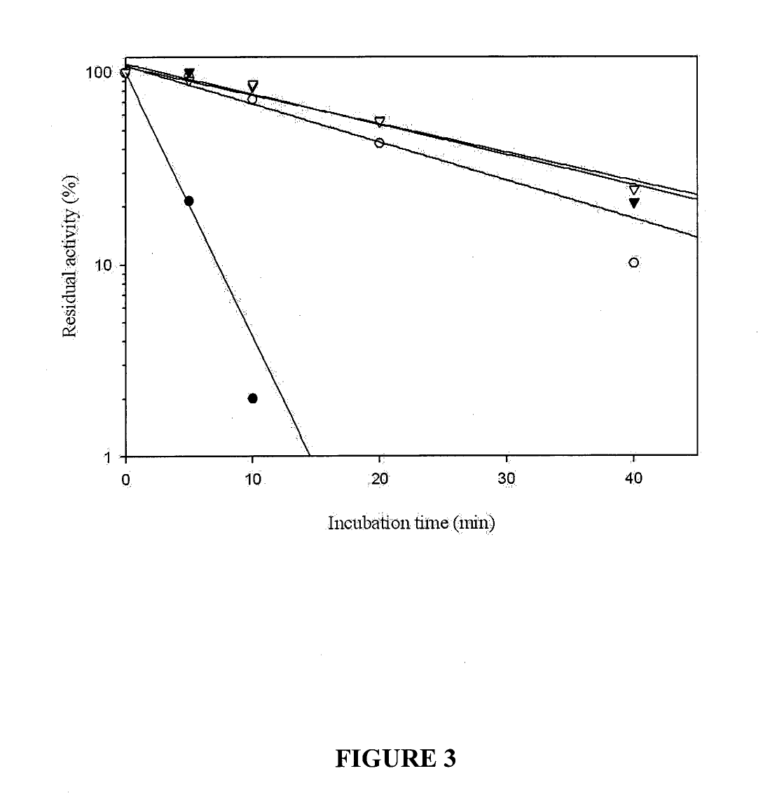

The thermal inactivation at 85° C. for wild-type Cel8A and the mutants is shown in FIG. 3. Thermal melting points are shown in Table 2. All the mutant enzymes showed significantly higher thermoresistance than that of the wild-type enzyme. Wild-type Cel8A lost 99% of its initial activity on CMC (956.6 U/mg) within 14 min after exposure to 85° C., whereas the evolved mutants demonstrated much improved thermostability (8 to 11 fold over that of the wild-type). Mutants TM and DM1 retained 57% and 60% of their initial activity (952.6 U/mg and 740.5 U/mg) after exposure to 85° C. for 20 min. Mutant SG retained 45% of its initial activity (760.2 U/mg) after exposure to 85° C. for 20 min. The catalytic efficiency was also determined on CMC and the specific activity was determined on both CMC and phosphoric acid-swollen cellulose (PASC). The results are shown in Table 2. The kinetic parameters of the purified mutants and parent enzyme showed that the enhanced thermostability gained by the S329G mutation reduces its catalytic efficiency by 22%. This reduction is also reflected in the initial activity performances on both CMC and PASC. DM1 showed a reduction of 42% in its catalytic efficiency and a greater reduction in the initial activity performances. Remarkably, the triple mutant (TM) that contains an addition of a S375T mutation is able to almost restore the catalytic efficiency and initial activity of the mutant, compared to the wild-type enzyme.

TABLE 2
Enzymatic properties of wild-type and thermostable mutants

| | | Activity | Activity | |
|---|---|---|---|---|
| | Tₘ^{app} | (U/mg)^{b} | (U/mg)^{b} | k_{cat}/Kₘ |
| | (° C.)^{a} | on CMC | on PASC | (min⁻¹ lg⁻¹) |
| Cel8A | 80.5 | 956.6 | 610.0 | 88.4 |
| SG | 87.5 | 760.2 | 591.6 | 69.2 |
| DM1 | 86.5 | 740.5 | 488.8 | 51.9 |
| TM | 87 | 952.6 | 565.2 | 84.6 |

^{a}Tₘ^{app} is the approximate mid-point temperature of melting determined by CD spectroscopy at 222 nm.
^{b}Purified enzyme was incubated with 0.5% (wt/vol) solutions at 65° C. for 1 h with occasional shaking. Activities were determined by assaying the release of reducing sugars.

### Example 5

### Structural Analysis of the Mutations

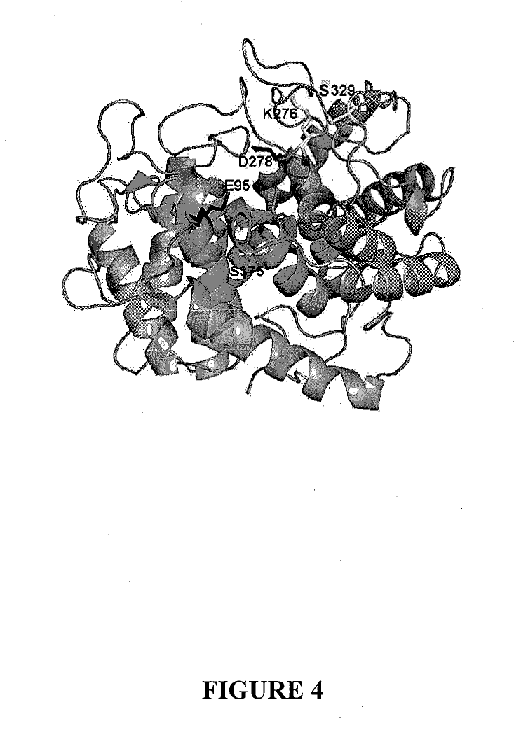

By far, the most influential mutation that conferred the most significant thermostability upon C. thermocellum Cel8A was the serine-to-glycine substitution at position 329. FIG. 4 shows the secondary structural elements that form the (α/α)₆ barrel structure of the Cel8A catalytic module, as determined by Alzari et al. S329 is located on a loop between helices 9 and 10 of the barrel on the surface of the protein. It forms a hydrogen bond with D319 and can also form hydrogen bonds with the water molecules of the solvent. Replacement of serine by glycine results in loss of hydrogen bonds and may contribute to an increase in structural flexibility.

The lysine at position 276 is located on a loop between helices 7 and 8 on the surface of the protein and is in close proximity to the active site cleft. It makes contact with D274 and can also form hydrogen bonds with the water molecules of the solvent. The replacement of lysine by arginine is rather conservative. Both are positively charged and both have large hydrophobic aliphatic side chains (Berezovsky et al., PLoS Comput Biol 2005, 1, e47). However, the substitution of lysine by arginine could improve thermostability by replacing water-mediated hydrogen bonds made by the lysine side chain with direct hydrogen bonds of the guanidinium group that protrudes further in space.

The third mutation which showed an additive effect on residual activity was the substitution of serine to threonine at position 375 located in helix 12 of Cel8A. Threonine maintains the side chain hydroxyl group but introduces an extra methyl group. This conservative substitution may contribute to better internal packing and by enhancing the hydrophobic interaction in the interior of the protein molecule. This substitution has the least additive influence on the observed thermo stability, but served to increase enzyme activity.

### Example 6

### Consensus-Guided Mutagenesis: Construction and Screening of Libraries Containing Consensus Mutations

### Methods

Library construction: Plasmid pET28aCel8A containing the cel8A gene from Clostridium thermocellum ATCC 27405 was used to construct the library. The cel8A gene was amplified and digested with DNase I (Sigma). The resulting 50-200 by fragments were assembled by PCR in the presence of an equimolar mixture of 8 oligonucleotides encoding the consensus mutations (total of 10 pmol) as described previously (Herman et al., Protein Eng Des Sel, 2007, 20(5): p. 219-26). The primers are listed in Table 3 hereinbelow. The resulting library was cloned into the pET28 vector using the NcoI and XhoI restriction sites.

TABLE 3
Primers used (the codon changes are underlined)

| | | SEQ |
|---|---|---|
| Primer | | ID |
| name | Sequence 5′->3′ | NO: |
| L101M | GGTATGGGATACGGAATGCTTTTGGCGGTTTGC | 31 |
| D115G | CAGGCTTTGTTTGACGGTTTATACCGTTACGTA | 32 |
| L187I | ACATTGATAAACAATATTTACAACCATTGTGTA | 33 |
| Y224F | GCATGGTACAAAGTGTTTGCTCAATATACAGG | 34 |
| Y227F | CTTGTGTCTCCTGTAAATTGAGCATACACTTTG | 35 |
| (comp) | | |
| G283P | GATGCTACACGTTACCCGTGGAGAACTGCCGTG | 36 |
| F293Y | GTGGACTATTCATGGTATGGTGACCAGAGAGC | 37 |
| I323L | GTTGACGGATACACACTGCAAGGTTCAAAAATTAG | 38 |

Screening for thermostable endoglucanase variants: Transformed E. coli cells derived from the library of Cel8A variants were spread onto LB plates containing 50 kanamycin and incubated overnight at 37° C. The clones were picked and grown overnight at 37° C. in 96-well plates containing 0.5 ml LB, 50 μg/ml kanamycin and 0.1 mM isopropyl β-D-1-thiogalactopyranoside (IPTG). Proteins were extracted using PopCulture Reagent (Novagen) according to the product manual. A sample of the extracted solution was diluted in 50 mM sodium acetate (pH 6.0) and incubated at various temperatures and time periods. Residual activity was determined with 1% CMC, 10 mM CaCl₂ and 50 mM sodium acetate (pH 6.0) at 65° C. The amount of reducing sugars released by the enzyme was determined colorimetrically using 3,5-dinitrosalicylic acid (DNS) reagent.

### Results

The amino acid sequence of Cel8A from C. thermocellum was used to identify 18 homologous sequences in GenBank. The sequences were selected based on amino acid identity values of 30 to 60%. The following sequences were used for the consensus alignment:

gi_{—}220928180_ref_YP_{—}002505089.1 (family-8 glycoside hydrolase Clostridium cellulolyticum H10);

gi_{—}585231_sp_P37701.1_GUN2_CLOJO (cellulase 2 Clostridium josui);

gi_{—}256756512_ref_ZP_{—}05497268.1 (family-8 glycoside hydrolase Clostridium papyrosolvens DSM 2782);

gi_{—}110639233_ref_YP_{—}679442.1 (beta-glycosidase-like protein Cytophaga hutchinsonii ATCC 33406);

gi_{—}146298783_ref_YP_{—}001193374.1 (licheninase Flavobacterium johnsoniae UW101);

gi_{—}110640093_ref_YP_{—}680303.1 (b-glycosidase C. hutchinsonii ATCC 33406);

gi_{—}289640415_ref_ZP_{—}06472621.1 (family-8 glycoside hydrolase Ethanoligenens harbinense YUAN-3);

gi_{—}159896826_ref_YP_{—}001543073.1 (glycoside hydrolase family protein Herpetosiphon aurantiacus ATCC 23779);

gi_{—}159896827_ref_YP_{—}001543074.1 (cellulose-binding family II protein H. aurantiacus ATCC 23779);

gi_{—}182414080_ref_YP_{—}001819146.1 (glycoside hydrolase family protein Opitutus terrae PB90-1);

gi_{—}149176217_ref_ZP_{—}01854832.1 (endoglucanase Y Planctomyces maris DSM 8797);

gi_{—}149916766_ref_ZP_{—}01905268.1 (endoglucanase Y Plesiocystis pacifica SIR-1);

gi_{—}152997715_ref_YP_{—}001342550.1 (licheninase Marinomonas sp. MWYL1);

gi_{—}261404389_ref_YP_{—}003240630.1 (licheninase (Paenibacillus sp. Y412MC10);

gi_{—}15552945_dbj_BAB64835.1 (chitosanase-glucanase Paenibacillus fukuinensis);

gi_{—}229128022_ref_ZP_{—}04257004.1 (endoglucanase Bacillus cereus BDRD-Cer4);

gi_{—}228994572_ref_ZP_{—}04154406.1 (endoglucanase Bacillus pseudomycoides DSM 12442); and

gi_{—}83649405_ref_YP_{—}437840.1 (endoglucanase Y Hahella chejuensis KCTC 2396).

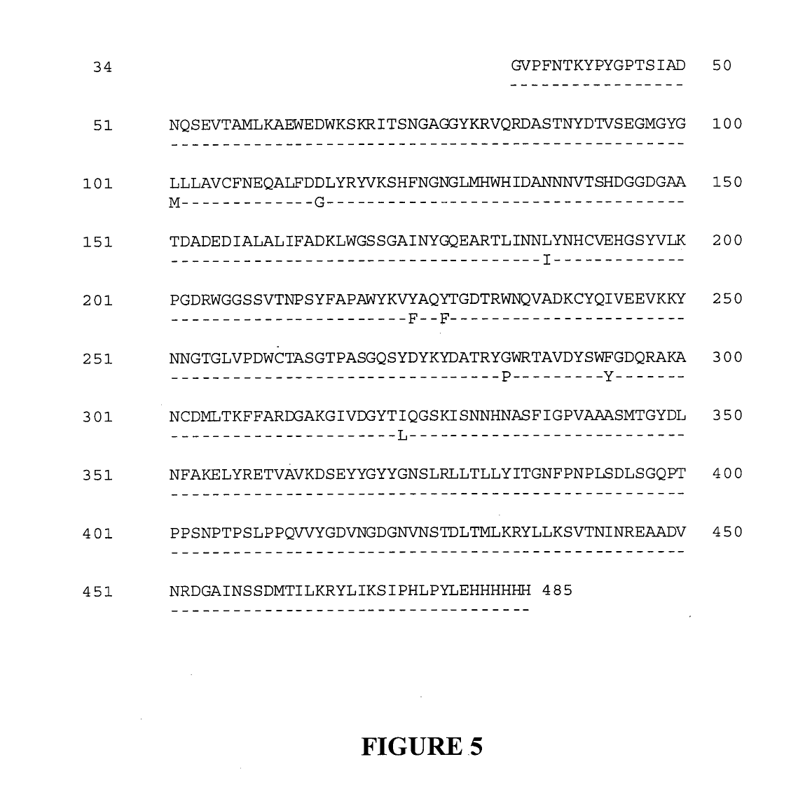

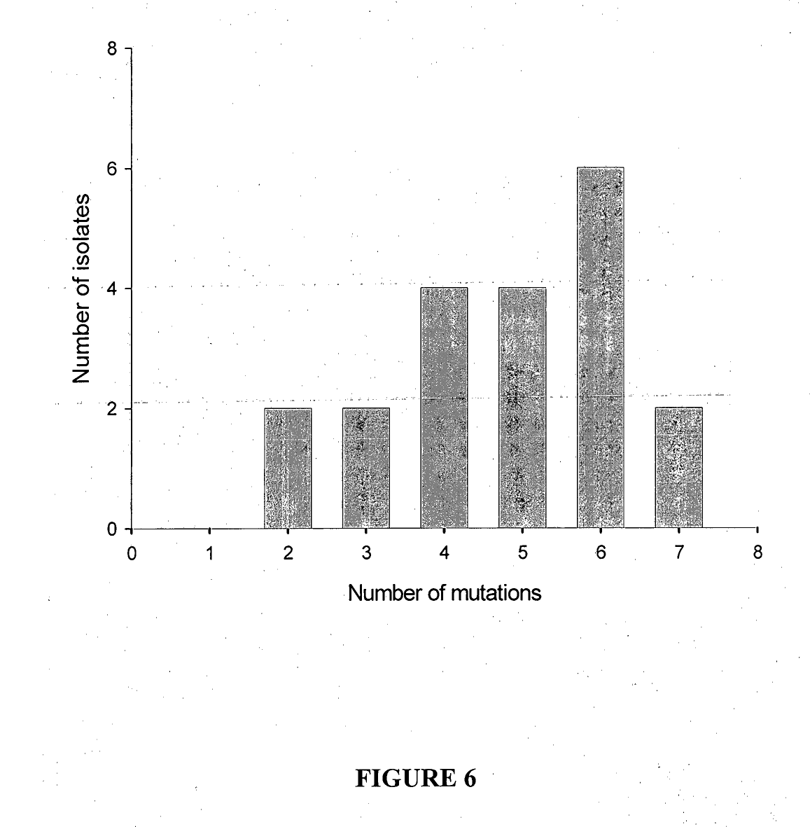

The sequences were aligned using the ClustalW algorithm and either consensus positions or most abundant positions were determined. Overall, the Cel8A gene differed in 8 positions from the consensus sequence (FIG. 5). It should be noted that many of the proteins used for the alignment were from mesophilic bacteria, e.g., Clostridium cellulolyticum and Flavobacterium johnsoniae, with an optimal temperature well below that of Cel8A for C. thermocellum. Eight oligonucleotide primers were designed, each containing a single codon replacement of the Cel8A gene with the matching consensus residue. In-vitro recombination was then used to produce an assembly of the different combinations of mutations. The resultant library was cloned into the pET28a expression vector and expressed in E. coli. The diversity of the genes in the resulting unselected library is presented in FIG. 6. All of the planned consensus mutations were observed in the library but in half of the genes one to two unplanned point mutations appeared that were introduced during the DNA fragment assembly.

Preliminary experiments for detection of active enzymes on a two-layer CMC-containing plate revealed that over 90% were active enzymes. Therefore, an initial screening step for activity prior to the thermostability screening was not necessary. The retention of endoglucanase activity was measured after heating the samples for 15 min at 82° C. After heating the Cel8A endoglucanase sample at this temperature the enzyme retained approximately 40% of its activity. Enzymes which showed enhanced thermostability after the heat treatment were considered candidates for further analysis.

In various methods which use random mutagenesis in order to generate thermostable mutants, large numbers of clones have to be screened before identifying the desired mutants. Using the consensus approach it is possible to screen significantly less clones and still acquire thermostable variants. Here, less than 600 clones were screened before the identification of 11 thermostable mutants that showed considerably higher residual activity after heat treatment compared to the wild-type Cel8A enzyme. The Cel8A gene from each of the positive clones was sequenced in order to determine the mutation(s) responsible for the increased thermostability.

### Example 7

### Identification of Mutations Responsible for Thermostability

### Methods

Site-directed mutagenesis: Single point mutations were generated in Cel8A using QuickChange site-directed mutagenesis kit (Stratagene). The primers that were used are listed in Table 4 hereinbelow. To verify that only the designated mutations were inserted by the Pfu Turbo DNA polymerase, the full Cel8A gene was sequenced.

TABLE 4
Primers used (the codon changes are underlined)

| | | SEQ |
|---|---|---|
| Primer | | ID |
| name | Sequence 5′->3′ | NO: |
| G177P + 1 | GGTGCAATAAACTACCCGCAGGAAGCAAGGACA | 39 |
| | TTG | |
| G177P + 2 | CAATGTCCTTGCTTCCTGCGGGTAGTTTATTGC | 40 |
| | ACC | |
| G373P + 1 | GAATATTACGGATATTACCCGAACAGCTTGAGA | 41 |
| | CTG | |
| G373P + 2 | CAGTCTCAAGCTGTTCGGGTAATATCCGTAATA | 42 |
| | TTC | |

Protein expression and purification: For detailed analysis of Cel8A and variants, E. coli BL21 (DE3) transformants were grown at 37° C. in LB supplemented with 50 kanamycin, until an OD₆₀₀ of ˜0.8 was reached. Overexpression was induced by adding 0.5 mM IPTG; the cultures were grown for another 3 h and harvested (4000×g, 15 min, 4° C.). The pellet was frozen overnight at −20° C. The cells were resuspended in Tris-buffered saline (TBS, 137 mM NaCl, 2.7 mM KCl, 25 mM Tris-HCl, pH 7.4) supplemented with 5 mM imidazole (Merck KGaA, Darmstadt, Germany) and protease-inhibitor cocktail (1 mM phenylmethylsulfonyl fluoride (PMSF), 0.4 mM benzamidine and 0.06 mM benzamide from Sigma-Aldrich, St. Louis, Mo.) and disrupted by sonication. The sonicate was heated for 30 min at 60° C. then centrifuged (20,000×g, 30 min, 4° C.). The soluble fraction was mixed with Ni-NTA (nitrilotriacetic acid), supplemented with 5-10 mM imidazole, for 1 h in an Econo-pack column at 4° C. (batch purification system). The column was then washed by gravity flow with 50 mM imidazole. Elution was preformed first using 100 mM imidazole, followed by 250 mM imidazole. Fractions (2 ml) were collected and analyzed by SDS-PAGE. The fractions containing the purified proteins were pooled and dialyzed extensively against 50 mM sodium acetate buffer at pH 6.0. Protein concentrations were determined by spectrophotometeric absorbance (280 nm) using the calculated molar absorption coefficient of the protein. Samples were stored at 4° C., supplemented with 0.02% sodium azide, or at −20° C. with 50% glycerol.

### Results

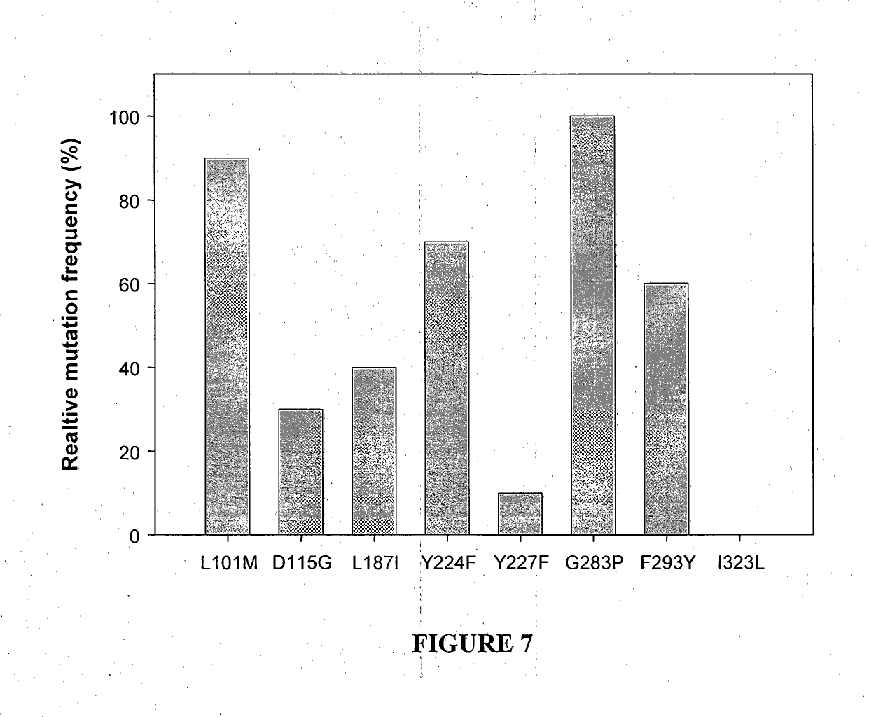

The ‘consensus approach’ enabled the identification of thermostable variants by combining multiple consensus mutations in different combinations. In order to determine which amino acid substitutions were responsible for the increased thermostability, the frequency of the individual consensus mutations in these variants were determined. The results, presented in FIG. 7, indicated that ⅞ of the consensus mutations appear in these stable variant but three of them (L101M, Y224F and G283P) are the most prevalent and were pursued further.

Site-directed mutagenesis was performed in order to determine the individual contribution of each of the three mutations. The results showed that a single mutation (G283P) was sufficient to produce the thermostable variant. The other two mutations did not contribute to its thermostability, and these variants showed wild-type levels of residual activity. Interestingly, mutation I323L did not appear in any of the stable mutants, but appeared in all the library variants that were completely inactivated upon a heat challenge. To confirm that the G283P variant was intrinsically thermostable, the enzyme was purified to homogeneity and the mutant was assayed for increased thermostability. The amino acid sequence and DNA sequence of the His-tagged G283P mutant are set forth in SEQ ID NOs: 22 and 24, respectively.

The results clearly confirmed that the mutant enzyme is considerably more stable than wild-type enzyme.

It has been previously shown that introduction of a proline at key sites could contribute to protein stabilization (see for example, Goihberg et al., Proteins, 2007, 66(1): p. 196-204; Zhou et al., J Biosci Bioeng, 2010, 110(1): p. 12-7; Tian et al., FEBS J, 2010, 277(23): p. 4901-8; Allen et al., Protein Eng, 1998, 11(9): p. 783-8). The G283P substitution occurred in the first turn of the α-helix 8. It was therefore interesting to determine whether the substitution of proline for glycine in other similar locations could improve the enzymes thermostability. Two glycines (G177 and G373) near the N-cap of helices 5 and 12 that were not conserved in the Cel8A family were chosen for substitution with proline by site-directed mutagenesis. Each glycine residue was individually mutated to proline and both enzymes were tested for activity and thermostabilty. The results showed that both enzymes maintained their initial activity levels but had significant reduction in thermostability compared to the wild-type enzyme.

### Example 8

### Additive Effect of the G283P Mutation to the Previously Engineered Thermostable Triple-Mutant Cel8A

As detailed above, the engineered triple mutant, TM (K276R/S329G/S375T) exhibited increased thermostability while maintaining wild-type levels of activity. It was therefore interesting to introduce the G283P mutation into the triple mutant to determine whether it could positively contribute to its stability. Site-directed mutagenesis was performed on the TM variant to create the QM (quadruple mutant) variant (K276R/G283P/S329G/S375T). The amino acid sequence and DNA sequence of the His-tagged QM are set forth in SEQ ID NOs: 18 and 20, respectively.

The enzymes were purified to homogeneity and their properties were determined and compared with that of wild-type enzyme. The 3.3° C. increase in Tₘ of the QM variant relative to the TM variant (Table 5) demonstrates that the thermostabilizing effect of G283P is additive.

TABLE 5
Thermostability of wild-type and thermostable mutants

| | | Tₘ^{app} | ΔTₘ | Rate constants |
|---|---|---|---|---|
| Variant | Mutations | (° C.)^{a} | (° C.) | Kᵢₙ (min⁻¹)^{b} |
| Cel8A | None | 80.7 | — | 1.558 |
| G283P | G283P | 84.2 | 3.5 | 1.318 |
| TM | K273R, S329G, S375T | 86.9 | 6.2 | 0.239 |
| QM | K273R, G283P, S329G, | 90.2 | 9.5 | 0.115 |
| | S375T | | | |

^{a}Tₘ^{app} is the approximate mid-point temperature of melting determined by CD spectroscopy at 222 nm.
^{b}The inactivation rate constants were deduced from plots of ln(percent residual activity) vs time at 85° C.

### Example 9

### Enzymatic Characterization of the Thermostable Quadruple-Mutant (QM)

### Methods

Enzymatic assays: Endoglucanase activity was measured by incubating the purified enzymes with 0.5% (wt/vol) of CMC or phosphoric acid-swollen cellulose (PASC) at 65° C. for 1 h with occasional shaking. Activities were determined by assaying the release of reducing sugars by the DNS method. Enzyme activity was expressed as units (U). One unit of endoglucanase activity corresponds to the release of 1 μmol of glucose equivalent per hour.

### Results

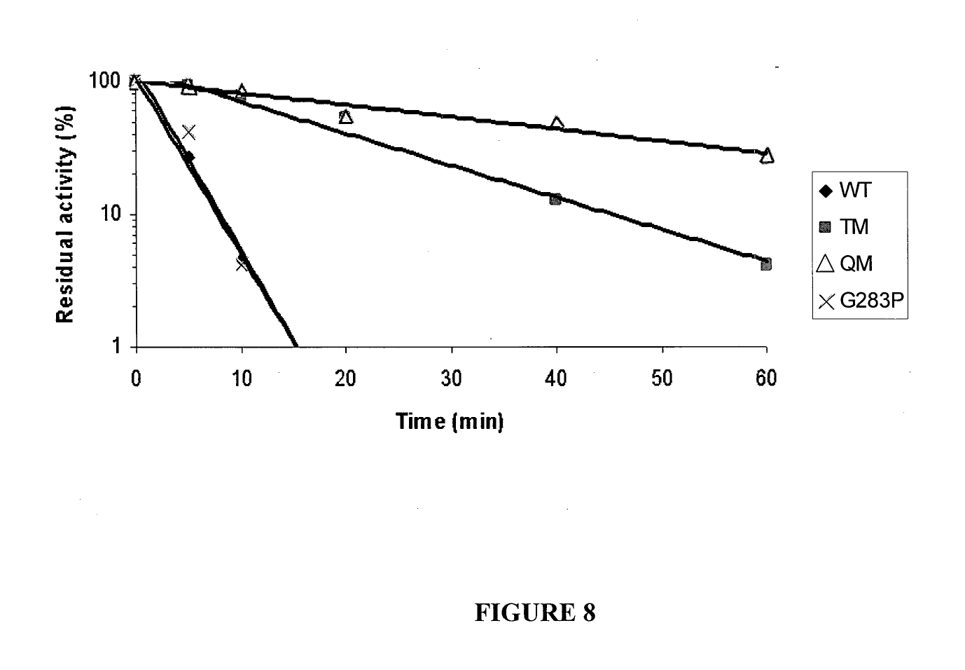

Kinetic analysis of the thermal inactivation of the wild-type Cel8A and the mutants at 85° C. followed first-order kinetics (FIG. 8). Thermal melting points are listed in Table 5 above. The introduction of a single proline at the second residue of helix-8 increased the Tₘ by 3.5° C. The introduction of the mutation into the TM triple mutant showed an additive effect, further increasing the Tₘ from 86.9° C. to 90.2° C. The Kᵢₙ of the QM variant was found to be 0.115 min⁻¹ which is 14-fold lower than that of wild-type Cel8A. The half-life of the QM variant at 85° C. was determined to be 34 min compared to 2.5 min of the wild-type Cel8A and 16 min of the TM variant.

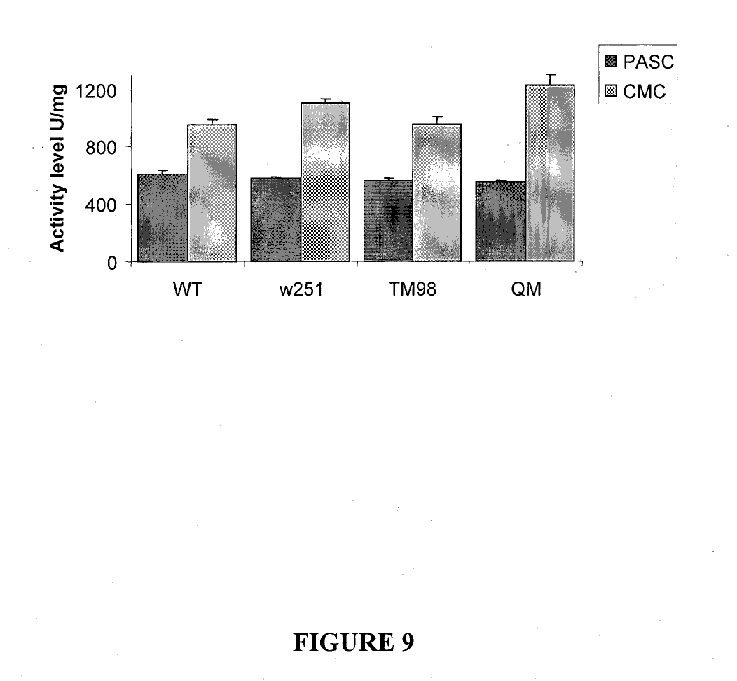

The specific activities of the mutants were determined on both CMC and phosphoric acid-swollen cellulose (PASC). As shown in FIG. 9, both the G283P and the QM variants demonstrate similar specific activities on CMC compared to the TM and wild-type enzymes. The G283P mutation demonstrated an increase in activity on PASC either as a single mutation or in combination with the TM variant (QM). The stability of the mutants was also determined at pH values of 3.0 to 9.0 and showed similar residual activities as the wild-type Cel8A enzyme.

### Example 10

### Structural Analysis of the Mutations

### Methods

Circular dichroism (CD) measurements: Melting curves were recorded on a Chirascan circular dichroism spectrometer (Applied Photophysics, Surrey, UK) in a 1-mm path-length cuvette. The proteins were used at about 5 μM concentration in 50 mM sodium acetate buffer at pH 6.0. The samples were heated at a rate of 1° C./min from 55 to 95° C., and the CD ellipticity signal at 222 nm, which showed the maximal change with the temperature, was monitored.

### Results

The CD spectra of the thermostable variants, namely, G283P, the TM and the QM, were analyzed to determine whether the mutation affected the secondary structure.

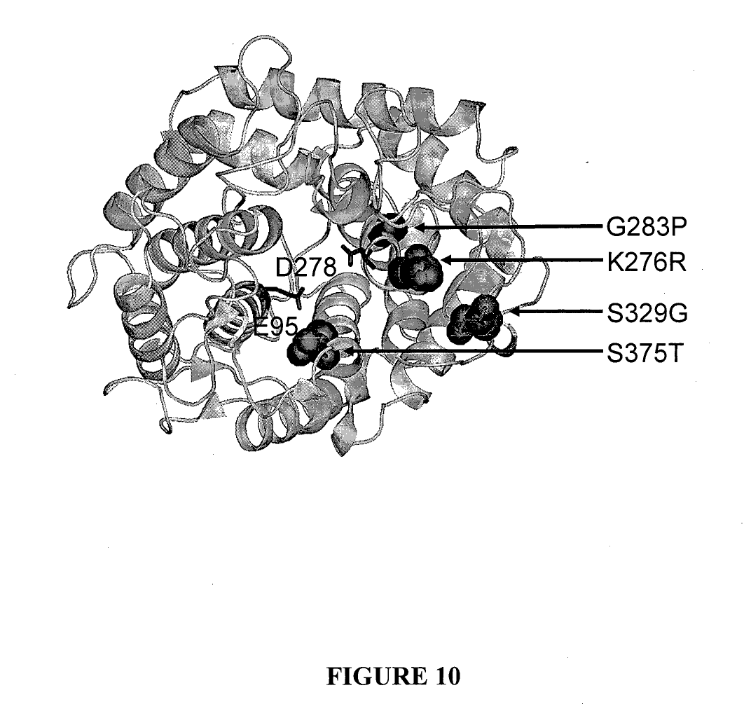

The results showed that there were no significant changes between the wild-type enzyme and the mutants with increased thermostability. FIG. 10 shows the three-dimensional structure of Cel8A as determined by Alzari et al and the mutations that were introduced in the present work. Without being bound by any particular theory or mechanism of action, the explanation for the increased thermostability appears to lie in the reduction of the conformational freedom of the protein backbone in its unfolded state. It has been reported that introduction of prolines at key positions, namely the first turn of the α-helix, the second site of the β-turn and in flexible loops, can stabilize proteins. Indeed, in many thermostable proteins there is an increase in the number of prolines at the N-terminus of α-helices (see for example, Watanabe et al., J Mol Biol, 1997, 269(1): p. 142-53). Because proline residue has a pyrrolidine ring, the backbone conformation of proline is constrained. The φ and ψ values of the proline residue is restricted, and, in addition, the φ and ψ values of the preceding residue are limited (Schimmel et al., J Mol Biol, 1968, 34(1): p. 105-20). Several reports have demonstrated the contribution of prolines in the first turn of α-helixes for themostabilization. For example, Tk-RNase HII from hyperthermophile Thermococcus kodakaraensis was thermostabilized by the introduction of prolines at the N-terminus of α-helices. Barley α-glucosidase was thermostabilized by replacing its N-cap Thr340 residue with proline (Muslin et al., Protein Eng, 2002, 15(1): p. 29-33).

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

1. A bio-engineered polypeptide variant of a family-8 cellulase comprising at least one amino acid substitution introduced into the catalytic domain of the enzyme and having an enhanced thermostability compared to the unaltered sequence.

2. The bio-engineered polypeptide variant of claim 1, wherein the at least one amino acid substitution is a non-native glycine (G) at the position corresponding to position 329 of Clostridium thermocellum Cel8A, said position being determined from sequence alignment of the unaltered sequence with the amino acid sequence of C. thermocellum Cel8A set forth in SEQ ID NO: 1.

3. The bio-engineered polypeptide variant of claim 2, further comprising an additional substitution selected from the group consisting of non-native arginine (R) at the position corresponding to position 276 of C. thermocellum Cel8A and non-native threonine (T) at the position corresponding to position 375 of C. thermocellum Cel8A, said positions being determined from sequence alignment of the unaltered sequence with the amino acid sequence of C. thermocellum Cel8A set forth in SEQ ID NO: 1.

4. The bio-engineered polypeptide variant of claim 2, further comprising a non-native arginine (R) at the position corresponding to position 276 of C. thermocellum Cel8A and a non-native threonine (T) at the position corresponding to position 375 of C. thermocellum Cel8A, said positions being determined from sequence alignment of the unaltered sequence with the amino acid sequence of C. thermocellum Cel8A set forth in SEQ ID NO: 1.

5. The bio-engineered polypeptide variant of claim 4, further comprising a non-native proline (P) at the position corresponding to position 283 of C. thermocellum Cel8A, said positions being determined from sequence alignment of the unaltered sequence with the amino acid sequence of C. thermocellum Cel8A set forth in SEQ ID NO: 1.

6. The bio-engineered polypeptide variant of claim 1, wherein the at least one amino acid substitution is a non-native proline (P) at the position corresponding to position 283 of C. thermocellum Cel8A, said position being determined from sequence alignment of the unaltered sequence with the amino acid sequence of C. thermocellum Cel8As set forth in SEQ ID NO: 1.

7. The bio-engineered polypeptide variant of claim 1, wherein the family-8 cellulase is the endoglucanase Cel8A from C. thermocellum.

8. The bio-engineered polypeptide variant of claim 7, comprising a serine (S) to glycine (G) substitution at position 329 of the polypeptide chain.

9. The bio-engineered polypeptide variant of claim 8, wherein the protein sequence of the variant is as set forth in SEQ ID NO. 5.

10. The bio-engineered polypeptide variant of claim 8, further comprising an additional substitution selected from the group consisting of lysine (K) to arginine (R) substitution at position 276 of the polypeptide chain and serine (S) to threonine (T) substitution at position 375 of the polypeptide chain.

11. The bio-engineered polypeptide variant of claim 10, wherein the protein sequence of the variant is selected from the group consisting of the sequences set forth in SEQ ID NO: 9 and SEQ ID NO: 43.

12. The bio-engineered polypeptide variant of claim 8, further comprising a lysine (K) to arginine (R) substitution at position 276 of the polypeptide chain and a serine (S) to threonine (T) substitution at position 375 of the polypeptide chain.

13. The bio-engineered polypeptide variant of claim 12, wherein the protein sequence of the variant is as set forth in SEQ ID NO. 13.

14. The bio-engineered polypeptide variant of claim 12, further comprising a glycine (G) to proline (P) substitution at position 283 of the polypeptide chain.

15. The bio-engineered polypeptide variant of claim 14, wherein the protein sequence of the variant is as set forth in SEQ ID NO: 17.

16. The bio-engineered polypeptide variant of claim 7, comprising a glycine (G) to proline (P) substitution at position 283 of the polypeptide chain.

17. The bio-engineered polypeptide variant of claim 16, wherein the protein sequence of the variant is as set forth in SEQ ID NO: 21.

18. An isolated polynucleotide encoding a bio-engineered polypeptide variant of a family-8 cellulase according to claim 1.

19. The isolated polynucleotide of claim 18, wherein the family-8 cellulase is the endoglucanase Cel8A from C. thermocellum.

20. The isolated polynucleotide of claim 19, comprising a sequence selected from the group consisting of SEQ ID NO. 7, SEQ ID NO. 11, SEQ ID NO. 15, SEQ ID NO: 19 and SEQ ID NO: 23.

21. A construct comprising the polynucleotide sequence of claim 18.

22. A genetically-modified cell capable of expressing and producing a bio-engineered polypeptide variant of a family-8 cellulase according to claim 1.

23. (canceled)

24. An artificial cellulosome complex comprising a bio-engineered polypeptide variant of a family-8 cellulase according to claim 1.

25. (canceled)

26. A method for degrading cellulosic material, the method comprising exposing said cellulosic material to cells according to claim 22.

27. (canceled)

28. A method for degrading cellulosic material, the method comprising exposing said cellulosic material to a bio-engineered polypeptide variant of a family-8 cellulase according to claim 1.


SEQUENCE LISTING (44 sequences)

SEQ ID NO: 1 - protein, 477 aa, Clostridium thermocellum
MKNVKKRVGVVLLILAVLGVYMLAMPANTVSAAGVPFNTKYPYGPTSIADNQSEVTAMLKAEWEDWKSKRITSNGAGGYKRVQRDASTNYDTVSEGMGYGLLLAVCFNEQALFDDLYRYVKSHFNGNGLMHWHIDANNNVTSHDGGDGAATDADEDIALALIFADKLWGSSGAINYGQEARTLINNLYNHCVEHGSYVLKPGDRWGGSSVTNPSYFAPAWYKVYAQYTGDTRWNQVADKCYQIVEEVKKYNNGTGLVPDWCTASGTPASGQSYDYKYDATRYGWRTAVDYSWFGDQRAKANCDMLTKFFARDGAKGIVDGYTIQGSKISNNHNASFIGPVAAASMTGYDLNFAKELYRETVAVKDSEYYGYYGNSLRLLTLLYITGNFPNPLSDLSGQPTPPSNPTPSLPPQVVYGDVNGDGNVNSTDLTMLKRYLLKSVTNINREAADVNRDGAINSSDMTILKRYLIKSIPHLPY

SEQ ID NO: 2 - DNA, 1934 bp, Clostridium thermocellum
atattaccctatcaaataacccattcaattcgcatttattttaagggagaaaattaactgtttgaagattatatatattttgaagattatatatatattcttttatttctgatttttaattctaatttgtataaacatgacaaaataaatatgatataatgattgtaaaggattggttggcataacggagactttaaggatgttattggtttggtaaatgtttttgggtaacgatatttatttttatttataatttttatttataaattttatattaaatttaaaaaggaggaaaaaaaagtgaagaacgtaaaaaaaagagtaggtgtggttttgctgattcttgcagtgttgggggtttatatgttggcaatgccggcaaacactgtgtcagcggcaggtgtgccttttaacacaaaatacccctatggtcctacttctattgccgataatcagtcggaagtaactgcaatgctcaaagcagaatgggaagactggaagagcaagagaattacctcgaacggtgcaggaggatacaagagagtacagcgtgatgcttccaccaattatgatacggtatccgaaggtatgggatacggacttcttttggcggtttgctttaacgaacaggctttgtttgacgatttataccgttacgtaaaatctcatttcaatggaaacggacttatgcactggcacattgatgccaacaacaatgttacaagtcatgacggcggcgacggtgcggcaaccgatgctgatgaggatattgcacttgcgctcatatttgcggacaagttatggggttcttccggtgcaataaactacgggcaggaagcaaggacattgataaacaatctttacaaccattgtgtagagcatggatcctatgtattaaagcccggtgacagatggggaggttcatcagtaacaaacccgtcatattttgcgcctgcatggtacaaagtgtatgctcaatatacaggagacacaagatggaatcaagtggcggacaagtgttaccaaattgttgaagaagttaagaaatacaacaacggaaccggccttgttcctgactggtgtactgcaagcggaactccggcaagcggtcagagttacgactacaaatatgatgctacacgttacggctggagaactgccgtggactattcatggtttggtgaccagagagcaaaggcaaactgcgatatgctgaccaaattctttgccagagacggggcaaaaggaatcgttgacggatacacaattcaaggttcaaaaattagcaacaatcacaacgcatcatttataggacctgttgcggcagcaagtatgacaggttacgatttgaactttgcaaaggaactttatagggagactgttgctgtaaaggacagtgaatattacggatattacggaaacagcttgagactgctcactttgttgtacataacaggaaacttcccgaatcctttgagtgacctttccggccaaccgacaccaccgtcgaatccgacaccttcattgcctcctcaggttgtttacggtgatgtaaatggcgacggtaatgttaactccactgatttgactatgttaaaaagatatctgctgaagagtgttaccaatataaacagagaggctgcagacgttaatcgtgacggtgcgattaactcctctgacatgactatattaaagagatatctgataaagagcataccccacctaccttattagtgtaatgggtttttgacagatttacggaaagagttactgcaaactacctgaataggtgggcagtaactctttttgttttcaagcctgttaataagaaattgttttgtaaagggtagcttgtaatatttgtattttggaggtctcttatgaaaaaaataccgttacttatgctgctgtcagcaataatatttttatcttta

SEQ ID NO: 3 - protein, 453 aa, Artificial Sequence
  Synthetic polypeptide
MGVPFNTKYPYGPTSIADNQSEVTAMLKAEWEDWKSKRITSNGAGGYKRVQRDASTNYDTVSEGMGYGLLLAVCFNEQALFDDLYRYVKSHFNGNGLMHWHIDANNNVTSHDGGDGAATDADEDIALALIFADKLWGSSGAINYGQEARTLINNLYNHCVEHGSYVLKPGDRWGGSSVTNPSYFAPAWYKVYAQYTGDTRWNQVADKCYQIVEEVKKYNNGTGLVPDWCTASGTPASGQSYDYKYDATRYGWRTAVDYSWFGDQRAKANCDMLTKFFARDGAKGIVDGYTIQGSKISNNHNASFIGPVAAASMTGYDLNFAKELYRETVAVKDSEYYGYYGNSLRLLTLLYITGNFPNPLSDLSGQPTPPSNPTPSLPPQVVYGDVNGDGNVNSTDLTMLKRYLLKSVTNINREAADVNRDGAINSSDMTILKRYLIKSIPHLPYLEHHHHHH

SEQ ID NO: 4 - DNA, 1359 bp, Artificial Sequence
  Synthetic polynucleotide
atgggtgtgccttttaacacaaaatacccctatggtcctacttctattgccgataatcagtcggaagtaactgcaatgctcaaagcagaatgggaagactggaagagcaagagaattacctcgaacggtgcaggaggatacaagagagtacagcgtgatgcttccaccaattatgatacggtatccgaaggtatgggatacggacttcttttggcggtttgctttaacgaacaggctttgtttgacgatttataccgttacgtaaaatctcatttcaatggaaacggacttatgcactggcacattgatgccaacaacaatgttacaagtcatgacggcggcgacggtgcggcaaccgatgctgatgaggatattgcacttgcgctcatatttgcggacaagttatggggttcttccggtgcaataaactacgggcaggaagcaaggacattgataaacaatctttacaaccattgtgtagagcatggatcctatgtattaaagcccggtgacagatggggaggttcatcagtaacaaacccgtcatattttgcgcctgcatggtacaaagtgtatgctcaatatacaggagacacaagatggaatcaagtggcggacaagtgttaccaaattgttgaagaagttaagaaatacaacaacggaaccggccttgttcctgactggtgtactgcaagcggaactccggcaagcggtcagagttacgactacaaatatgatgctacacgttacggctggagaactgccgtggactattcatggtttggtgaccagagagcaaaggcaaactgcgatatgctgaccaaattctttgccagagacggggcaaaaggaatcgttgacggatacacaattcaaggttcaaaaattagcaacaatcacaacgcatcatttataggacctgttgcggcagcaagtatgacaggttacgatttgaactttgcaaaggaactttatagggagactgttgctgtaaaggacagtgaatattacggatattacggaaacagcttgagactgctcactttgttgtacataacaggaaacttcccgaatcctttgagtgacctttccggccaaccgacaccaccgtcgaatccgacaccttcattgcctcctcaggttgtttacggtgatgtaaatggcgacggtaatgttaactccactgatttgactatgttaaaaagatatctgctgaagagtgttaccaatataaacagagaggctgcagacgttaatcgtgacggtgcgattaactcctctgacatgactatattaaagagatatctgataaagagcataccccacctaccttatctcgagcaccaccaccaccaccac

SEQ ID NO: 5 - protein, 447 aa, Artificial Sequence
  Synthetic polypeptide
MGVPFNTKYPYGPTSIADNQSEVTAMLKAEWEDWKSKRITSNGAGGYKRVQRDASTNYDTVSEGMGYGLLLAVCFNEQALFDDLYRYVKSHFNGNGLMHWHIDANNNVTSHDGGDGAATDADEDIALALIFADKLWGSSGAINYGQEARTLINNLYNHCVEHGSYVLKPGDRWGGSSVTNPSYFAPAWYKVYAQYTGDTRWNQVADKCYQIVEEVKKYNNGTGLVPDWCTASGTPASGQSYDYKYDATRYGWRTAVDYSWFGDQRAKANCDMLTKFFARDGAKGIVDGYTIQGSKIGNNHNASFIGPVAAASMTGYDLNFAKELYRETVAVKDSEYYGYYGNSLRLLTLLYITGNFPNPLSDLSGQPTPPSNPTPSLPPQVVYGDVNGDGNVNSTDLTMLKRYLLKSVTNINREAADVNRDGAINSSDMTILKRYLIKSIPHLPYLE

SEQ ID NO: 6 - protein, 453 aa, Artificial Sequence
  Synthetic polypeptide
MGVPFNTKYPYGPTSIADNQSEVTAMLKAEWEDWKSKRITSNGAGGYKRVQRDASTNYDTVSEGMGYGLLLAVCFNEQALFDDLYRYVKSHFNGNGLMHWHIDANNNVTSHDGGDGAATDADEDIALALIFADKLWGSSGAINYGQEARTLINNLYNHCVEHGSYVLKPGDRWGGSSVTNPSYFAPAWYKVYAQYTGDTRWNQVADKCYQIVEEVKKYNNGTGLVPDWCTASGTPASGQSYDYKYDATRYGWRTAVDYSWFGDQRAKANCDMLTKFFARDGAKGIVDGYTIQGSKIGNNHNASFIGPVAAASMTGYDLNFAKELYRETVAVKDSEYYGYYGNSLRLLTLLYITGNFPNPLSDLSGQPTPPSNPTPSLPPQVVYGDVNGDGNVNSTDLTMLKRYLLKSVTNINREAADVNRDGAINSSDMTILKRYLIKSIPHLPYLEHHHHHH

SEQ ID NO: 7 - DNA, 1341 bp, Artificial Sequence
  Synthetic polynucleotide
atgggtgtgccttttaacacaaaatacccctatggtcctacttctattgccgataatcagtcggaagtaactgcaatgctcaaagcagaatgggaagactggaagagcaagagaattacctcgaacggtgcaggaggatacaagagagtacagcgtgatgcttccaccaattatgatacggtatccgaaggtatgggatacggacttcttttggcggtttgctttaacgaacaggctttgtttgacgatttataccgttacgtaaaatctcatttcaatggaaacggacttatgcactggcacattgatgccaacaacaatgttacaagtcatgacggcggcgacggtgcggcaaccgatgctgatgaggatattgcacttgcgctcatatttgcggacaagttatggggttcttccggtgcaataaactacgggcaggaagcaaggacattgataaacaatctttacaaccattgtgtagagcatggatcctatgtattaaagcccggtgacagatggggaggttcatcagtaacaaacccgtcatattttgcgcctgcatggtacaaagtgtatgctcaatatacaggagacacaagatggaatcaagtggcggacaagtgttaccaaattgttgaagaagttaagaaatacaacaacggaaccggccttgttcctgactggtgtactgcaagcggaactccggcaagcggtcagagttacgactacaaatatgatgctacacgttacggctggagaactgccgtggactattcatggtttggtgaccagagagcaaaggcaaactgcgatatgctgaccaaattctttgccagagacggggcaaaaggaatcgttgacggatacacaattcaaggttcaaaaattggcaacaatcacaacgcatcatttataggacctgttgcggcagcaagtatgacaggttacgatttgaactttgcaaaggaactttatagggagactgttgctgtaaaggacagtgaatattacggatattacggaaacagcttgagactgctcactttgttgtacataacaggaaacttcccgaatcctttgagtgacctttccggccaaccgacaccaccgtcgaatccgacaccttcattgcctcctcaggttgtttacggtgatgtaaatggcgacggtaatgttaactccactgatttgactatgttaaaaagatatctgctgaagagtgttaccaatataaacagagaggctgcagacgttaatcgtgacggtgcgattaactcctctgacatgactatattaaagagatatctgataaagagcataccccacctaccttatctcgag

SEQ ID NO: 8 - DNA, 1359 bp, Artificial Sequence
  Synthetic polynucleotide
atgggtgtgccttttaacacaaaatacccctatggtcctacttctattgccgataatcagtcggaagtaactgcaatgctcaaagcagaatgggaagactggaagagcaagagaattacctcgaacggtgcaggaggatacaagagagtacagcgtgatgcttccaccaattatgatacggtatccgaaggtatgggatacggacttcttttggcggtttgctttaacgaacaggctttgtttgacgatttataccgttacgtaaaatctcatttcaatggaaacggacttatgcactggcacattgatgccaacaacaatgttacaagtcatgacggcggcgacggtgcggcaaccgatgctgatgaggatattgcacttgcgctcatatttgcggacaagttatggggttcttccggtgcaataaactacgggcaggaagcaaggacattgataaacaatctttacaaccattgtgtagagcatggatcctatgtattaaagcccggtgacagatggggaggttcatcagtaacaaacccgtcatattttgcgcctgcatggtacaaagtgtatgctcaatatacaggagacacaagatggaatcaagtggcggacaagtgttaccaaattgttgaagaagttaagaaatacaacaacggaaccggccttgttcctgactggtgtactgcaagcggaactccggcaagcggtcagagttacgactacaaatatgatgctacacgttacggctggagaactgccgtggactattcatggtttggtgaccagagagcaaaggcaaactgcgatatgctgaccaaattctttgccagagacggggcaaaaggaatcgttgacggatacacaattcaaggttcaaaaattggcaacaatcacaacgcatcatttataggacctgttgcggcagcaagtatgacaggttacgatttgaactttgcaaaggaactttatagggagactgttgctgtaaaggacagtgaatattacggatattacggaaacagcttgagactgctcactttgttgtacataacaggaaacttcccgaatcctttgagtgacctttccggccaaccgacaccaccgtcgaatccgacaccttcattgcctcctcaggttgtttacggtgatgtaaatggcgacggtaatgttaactccactgatttgactatgttaaaaagatatctgctgaagagtgttaccaatataaacagagaggctgcagacgttaatcgtgacggtgcgattaactcctctgacatgactatattaaagagatatctgataaagagcataccccacctaccttatctcgagcaccaccaccaccaccac

SEQ ID NO: 9 - protein, 447 aa, Artificial Sequence
  Synthetic polypeptide
MGVPFNTKYPYGPTSIADNQSEVTAMLKAEWEDWKSKRITSNGAGGYKRVQRDASTNYDTVSEGMGYGLLLAVCFNEQALFDDLYRYVKSHFNGNGLMHWHIDANNNVTSHDGGDGAATDADEDIALALIFADKLWGSSGAINYGQEARTLINNLYNHCVEHGSYVLKPGDRWGGSSVTNPSYFAPAWYKVYAQYTGDTRWNQVADKCYQIVEEVKKYNNGTGLVPDWCTASGTPASGQSYDYRYDATRYGWRTAVDYSWFGDQRAKANCDMLTKFFARDGAKGIVDGYTIQGSKIGNNHNASFIGPVAAASMTGYDLNFAKELYRETVAVKDSEYYGYYGNSLRLLTLLYITGNFPNPLSDLSGQPTPPSNPTPSLPPQVVYGDVNGDGNVNSTDLTMLKRYLLKSVTNINREAADVNRDGAINSSDMTILKRYLIKSIPHLPYLE

SEQ ID NO: 10 - protein, 453 aa, Artificial Sequence
  Synthetic polypeptide
MGVPFNTKYPYGPTSIADNQSEVTAMLKAEWEDWKSKRITSNGAGGYKRVQRDASTNYDTVSEGMGYGLLLAVCFNEQALFDDLYRYVKSHFNGNGLMHWHIDANNNVTSHDGGDGAATDADEDIALALIFADKLWGSSGAINYGQEARTLINNLYNHCVEHGSYVLKPGDRWGGSSVTNPSYFAPAWYKVYAQYTGDTRWNQVADKCYQIVEEVKKYNNGTGLVPDWCTASGTPASGQSYDYRYDATRYGWRTAVDYSWFGDQRAKANCDMLTKFFARDGAKGIVDGYTIQGSKIGNNHNASFIGPVAAASMTGYDLNFAKELYRETVAVKDSEYYGYYGNSLRLLTLLYITGNFPNPLSDLSGQPTPPSNPTPSLPPQVVYGDVNGDGNVNSTDLTMLKRYLLKSVTNINREAADVNRDGAINSSDMTILKRYLIKSIPHLPYLEHHHHHH

SEQ ID NO: 11 - DNA, 1341 bp, Artificial Sequence
  Synthetic polynucleotide
atgggtgtgccttttaacacaaaatacccctatggtcctacttctattgccgataatcagtcggaagtaactgcaatgctcaaagcagaatgggaagactggaagagcaagagaattacctcgaacggtgcaggaggatacaagagagtacagcgtgatgcttccaccaattatgatacggtatccgaaggtatgggatacggacttcttttggcggtttgctttaacgaacaggctttgtttgacgatttataccgttacgtaaaatctcatttcaatggaaacggacttatgcactggcacattgatgccaacaacaatgttacaagtcatgacggcggcgacggtgcggcaaccgatgctgatgaggatattgcacttgcgctcatatttgcggacaagttatggggttcttccggtgcaataaactacgggcaggaagcaaggacattgataaacaatctttacaaccattgtgtagagcatggatcctatgtattaaagcccggtgacagatggggaggttcatcagtaacaaacccgtcatattttgcgcctgcatggtacaaagtgtatgctcaatatacaggagacacaagatggaatcaagtggcggacaagtgttaccaaattgttgaagaagttaagaaatacaacaacggaaccggccttgttcctgactggtgtactgcaagcggaactccggcaagcggtcagagttacgactacagatatgatgctacacgttacggctggagaactgccgtggactattcatggtttggtgaccagagagcaaaggcaaactgcgatatgctgaccaaattctttgccagagacggggcaaaaggaatcgttgacggatacacaattcaaggttcaaaaattggcaacaatcacaacgcatcatttataggacctgttgcggcagcaagtatgacaggttacgatttgaactttgcaaaggaactttatagggagactgttgctgtaaaggacagtgaatattacggatattacggaaacagcttgagactgctcactttgttgtacataacaggaaacttcccgaatcctttgagtgacctttccggccaaccgacaccaccgtcgaatccgacaccttcattgcctcctcaggttgtttacggtgatgtaaatggcgacggtaatgttaactccactgatttgactatgttaaaaagatatctgctgaagagtgttaccaatataaacagagaggctgcagacgttaatcgtgacggtgcgattaactcctctgacatgactatattaaagagatatctgataaagagcataccccacctaccttatctcgag

SEQ ID NO: 12 - DNA, 1359 bp, Artificial Sequence
  Synthetic polynucleotide
atgggtgtgccttttaacacaaaatacccctatggtcctacttctattgccgataatcagtcggaagtaactgcaatgctcaaagcagaatgggaagactggaagagcaagagaattacctcgaacggtgcaggaggatacaagagagtacagcgtgatgcttccaccaattatgatacggtatccgaaggtatgggatacggacttcttttggcggtttgctttaacgaacaggctttgtttgacgatttataccgttacgtaaaatctcatttcaatggaaacggacttatgcactggcacattgatgccaacaacaatgttacaagtcatgacggcggcgacggtgcggcaaccgatgctgatgaggatattgcacttgcgctcatatttgcggacaagttatggggttcttccggtgcaataaactacgggcaggaagcaaggacattgataaacaatctttacaaccattgtgtagagcatggatcctatgtattaaagcccggtgacagatggggaggttcatcagtaacaaacccgtcatattttgcgcctgcatggtacaaagtgtatgctcaatatacaggagacacaagatggaatcaagtggcggacaagtgttaccaaattgttgaagaagttaagaaatacaacaacggaaccggccttgttcctgactggtgtactgcaagcggaactccggcaagcggtcagagttacgactacagatatgatgctacacgttacggctggagaactgccgtggactattcatggtttggtgaccagagagcaaaggcaaactgcgatatgctgaccaaattctttgccagagacggggcaaaaggaatcgttgacggatacacaattcaaggttcaaaaattggcaacaatcacaacgcatcatttataggacctgttgcggcagcaagtatgacaggttacgatttgaactttgcaaaggaactttatagggagactgttgctgtaaaggacagtgaatattacggatattacggaaacagcttgagactgctcactttgttgtacataacaggaaacttcccgaatcctttgagtgacctttccggccaaccgacaccaccgtcgaatccgacaccttcattgcctcctcaggttgtttacggtgatgtaaatggcgacggtaatgttaactccactgatttgactatgttaaaaagatatctgctgaagagtgttaccaatataaacagagaggctgcagacgttaatcgtgacggtgcgattaactcctctgacatgactatattaaagagatatctgataaagagcataccccacctaccttatctcgagcaccaccaccaccaccac

SEQ ID NO: 13 - protein, 447 aa, Artificial Sequence
  Synthetic polypeptide
MGVPFNTKYPYGPTSIADNQSEVTAMLKAEWEDWKSKRITSNGAGGYKRVQRDASTNYDTVSEGMGYGLLLAVCFNEQALFDDLYRYVKSHFNGNGLMHWHIDANNNVTSHDGGDGAATDADEDIALALIFADKLWGSSGAINYGQEARTLINNLYNHCVEHGSYVLKPGDRWGGSSVTNPSYFAPAWYKVYAQYTGDTRWNQVADKCYQIVEEVKKYNNGTGLVPDWCTASGTPASGQSYDYRYDATRYGWRTAVDYSWFGDQRAKANCDMLTKFFARDGAKGIVDGYTIQGSKIGNNHNASFIGPVAAASMTGYDLNFAKELYRETVAVKDSEYYGYYGNTLRLLTLLYITGNFPNPLSDLSGQPTPPSNPTPSLPPQVVYGDVNGDGNVNSTDLTMLKRYLLKSVTNINREAADVNRDGAINSSDMTILKRYLIKSIPHLPYLE

SEQ ID NO: 14 - protein, 453 aa, Artificial Sequence
  Synthetic polypeptide
MGVPFNTKYPYGPTSIADNQSEVTAMLKAEWEDWKSKRITSNGAGGYKRVQRDASTNYDTVSEGMGYGLLLAVCFNEQALFDDLYRYVKSHFNGNGLMHWHIDANNNVTSHDGGDGAATDADEDIALALIFADKLWGSSGAINYGQEARTLINNLYNHCVEHGSYVLKPGDRWGGSSVTNPSYFAPAWYKVYAQYTGDTRWNQVADKCYQIVEEVKKYNNGTGLVPDWCTASGTPASGQSYDYRYDATRYGWRTAVDYSWFGDQRAKANCDMLTKFFARDGAKGIVDGYTIQGSKIGNNHNASFIGPVAAASMTGYDLNFAKELYRETVAVKDSEYYGYYGNTLRLLTLLYITGNFPNPLSDLSGQPTPPSNPTPSLPPQVVYGDVNGDGNVNSTDLTMLKRYLLKSVTNINREAADVNRDGAINSSDMTILKRYLIKSIPHLPYLEHHHHHH

SEQ ID NO: 15 - DNA, 1341 bp, Artificial Sequence
  Synthetic polynucleotide
atgggtgtgccttttaacacaaaatacccctatggtcctacttctattgccgataatcagtcggaagtaactgcaatgctcaaagcagaatgggaagactggaagagcaagagaattacctcgaacggtgcaggaggatacaagagagtacagcgtgatgcttccaccaattatgatacggtatccgaaggtatgggatacggacttcttttggcggtttgctttaacgaacaggctttgtttgacgatttataccgttacgtaaaatctcatttcaatggaaacggacttatgcactggcacattgatgccaacaacaatgttacaagtcatgacggcggcgacggtgcggcaaccgatgctgatgaggatattgcacttgcgctcatatttgcggacaagttatggggttcttccggtgcaataaactacgggcaggaagcaaggacattgataaacaatctttacaaccattgtgtagagcatggatcctatgtattaaagcccggtgacagatggggaggttcatcagtaacaaacccgtcatattttgcgcctgcatggtacaaagtgtatgctcaatatacaggagacacaagatggaatcaagtggcggacaagtgttaccaaattgttgaagaagttaagaaatacaacaacggaaccggccttgttcctgactggtgtactgcaagcggaactccggcaagcggtcagagttacgactacagatatgatgctacacgttacggctggagaactgccgtggactattcatggtttggtgaccagagagcaaaggcaaactgcgatatgctgaccaaattctttgccagagacggggcaaaaggaatcgttgacggatacacaattcaaggttcaaaaattggcaacaatcacaacgcatcatttataggacctgttgcggcagcaagtatgacaggttacgatttgaactttgcaaaggaactttatagggagactgttgctgtaaaggacagtgaatattacggatattacggaaacaccttgagactgctcactttgttgtacataacaggaaacttcccgaatcctttgagtgacctttccggccaaccgacaccaccgtcgaatccgacaccttcattgcctcctcaggttgtttacggtgatgtaaatggcgacggtaatgttaactccactgatttgactatgttaaaaagatatctgctgaagagtgttaccaatataaacagagaggctgcagacgttaatcgtgacggtgcgattaactcctctgacatgactatattaaagagatatctgataaagagcataccccacctaccttatctcgag

SEQ ID NO: 16 - DNA, 1359 bp, Artificial Sequence
  Synthetic polynucleotide
atgggtgtgccttttaacacaaaatacccctatggtcctacttctattgccgataatcagtcggaagtaactgcaatgctcaaagcagaatgggaagactggaagagcaagagaattacctcgaacggtgcaggaggatacaagagagtacagcgtgatgcttccaccaattatgatacggtatccgaaggtatgggatacggacttcttttggcggtttgctttaacgaacaggctttgtttgacgatttataccgttacgtaaaatctcatttcaatggaaacggacttatgcactggcacattgatgccaacaacaatgttacaagtcatgacggcggcgacggtgcggcaaccgatgctgatgaggatattgcacttgcgctcatatttgcggacaagttatggggttcttccggtgcaataaactacgggcaggaagcaaggacattgataaacaatctttacaaccattgtgtagagcatggatcctatgtattaaagcccggtgacagatggggaggttcatcagtaacaaacccgtcatattttgcgcctgcatggtacaaagtgtatgctcaatatacaggagacacaagatggaatcaagtggcggacaagtgttaccaaattgttgaagaagttaagaaatacaacaacggaaccggccttgttcctgactggtgtactgcaagcggaactccggcaagcggtcagagttacgactacagatatgatgctacacgttacggctggagaactgccgtggactattcatggtttggtgaccagagagcaaaggcaaactgcgatatgctgaccaaattctttgccagagacggggcaaaaggaatcgttgacggatacacaattcaaggttcaaaaattggcaacaatcacaacgcatcatttataggacctgttgcggcagcaagtatgacaggttacgatttgaactttgcaaaggaactttatagggagactgttgctgtaaaggacagtgaatattacggatattacggaaacaccttgagactgctcactttgttgtacataacaggaaacttcccgaatcctttgagtgacctttccggccaaccgacaccaccgtcgaatccgacaccttcattgcctcctcaggttgtttacggtgatgtaaatggcgacggtaatgttaactccactgatttgactatgttaaaaagatatctgctgaagagtgttaccaatataaacagagaggctgcagacgttaatcgtgacggtgcgattaactcctctgacatgactatattaaagagatatctgataaagagcataccccacctaccttatctcgagcaccaccaccaccaccac

SEQ ID NO: 17 - protein, 447 aa, Artificial Sequence
  Synthetic polypeptide
MGVPFNTKYPYGPTSIADNQSEVTAMLKAEWEDWKSKRITSNGAGGYKRVQRDASTNYDTVSEGMGYGLLLAVCFNEQALFDDLYRYVKSHFNGNGLMHWHIDANNNVTSHDGGDGAATDADEDIALALIFADKLWGSSGAINYGQEARTLINNLYNHCVEHGSYVLKPGDRWGGSSVTNPSYFAPAWYKVYAQYTGDTRWNQVADKCYQIVEEVKKYNNGTGLVPDWCTASGTPASGQSYDYRYDATRYPWRTAVDYSWFGDQRAKANCDMLTKFFARDGAKGIVDGYTIQGSKIGNNHNASFIGPVAAASMTGYDLNFAKELYRETVAVKDSEYYGYYGNTLRLLTLLYITGNFPNPLSDLSGQPTPPSNPTPSLPPQVVYGDVNGDGNVNSTDLTMLKRYLLKSVTNINREAADVNRDGAINSSDMTILKRYLIKSIPHLPYLE

SEQ ID NO: 18 - protein, 453 aa, Artificial Sequence
  Synthetic polypeptide
MGVPFNTKYPYGPTSIADNQSEVTAMLKAEWEDWKSKRITSNGAGGYKRVQRDASTNYDTVSEGMGYGLLLAVCFNEQALFDDLYRYVKSHFNGNGLMHWHIDANNNVTSHDGGDGAATDADEDIALALIFADKLWGSSGAINYGQEARTLINNLYNHCVEHGSYVLKPGDRWGGSSVTNPSYFAPAWYKVYAQYTGDTRWNQVADKCYQIVEEVKKYNNGTGLVPDWCTASGTPASGQSYDYRYDATRYPWRTAVDYSWFGDQRAKANCDMLTKFFARDGAKGIVDGYTIQGSKIGNNHNASFIGPVAAASMTGYDLNFAKELYRETVAVKDSEYYGYYGNTLRLLTLLYITGNFPNPLSDLSGQPTPPSNPTPSLPPQVVYGDVNGDGNVNSTDLTMLKRYLLKSVTNINREAADVNRDGAINSSDMTILKRYLIKSIPHLPYLEHHHHHH

SEQ ID NO: 19 - DNA, 1341 bp, Artificial Sequence
  Synthetic polynucleotide
atgggtgtgccttttaacacaaaatacccctatggtcctacttctattgccgataatcagtcggaagtaactgcaatgctcaaagcagaatgggaagactggaagagcaagagaattacctcgaacggtgcaggaggatacaagagagtacagcgtgatgcttccaccaattatgatacggtatccgaaggtatgggatacggacttcttttggcggtttgctttaacgaacaggctttgtttgacgatttataccgttacgtaaaatctcatttcaatggaaacggacttatgcactggcacattgatgccaacaacaatgttacaagtcatgacggcggcgacggtgcggcaaccgatgctgatgaggatattgcacttgcgctcatatttgcggacaagttatggggttcttccggtgcaataaactacgggcaggaagcaaggacattgataaacaatctttacaaccattgtgtagagcatggatcctatgtattaaagcccggtgacagatggggaggttcatcagtaacaaacccgtcatattttgcgcctgcatggtacaaagtgtatgctcaatatacaggagacacaagatggaatcaagtggcggacaagtgttaccaaattgttgaagaagttaagaaatacaacaacggaaccggccttgttcctgactggtgtactgcaagcggaactccggcaagcggtcagagttacgactacagatatgatgctacacgttacccgtggagaactgccgtggactattcatggtttggtgaccagagagcaaaggcaaactgcgatatgctgaccaaattctttgccagagacggggcaaaaggaatcgttgacggatacacaattcaaggttcaaaaattggcaacaatcacaacgcatcatttataggacctgttgcggcagcaagtatgacaggttacgatttgaactttgcaaaggaactttatagggagactgttgctgtaaaggacagtgaatattacggatattacggaaacaccttgagactgctcactttgttgtacataacaggaaacttcccgaatcctttgagtgacctttccggccaaccgacaccaccgtcgaatccgacaccttcattgcctcctcaggttgtttacggtgatgtaaatggcgacggtaatgttaactccactgatttgactatgttaaaaagatatctgctgaagagtgttaccaatataaacagagaggctgcagacgttaatcgtgacggtgcgattaactcctctgacatgactatattaaagagatatctgataaagagcataccccacctaccttatctcgag

SEQ ID NO: 20 - DNA, 1359 bp, Artificial Sequence
  Synthetic polynucleotide
atgggtgtgccttttaacacaaaatacccctatggtcctacttctattgccgataatcagtcggaagtaactgcaatgctcaaagcagaatgggaagactggaagagcaagagaattacctcgaacggtgcaggaggatacaagagagtacagcgtgatgcttccaccaattatgatacggtatccgaaggtatgggatacggacttcttttggcggtttgctttaacgaacaggctttgtttgacgatttataccgttacgtaaaatctcatttcaatggaaacggacttatgcactggcacattgatgccaacaacaatgttacaagtcatgacggcggcgacggtgcggcaaccgatgctgatgaggatattgcacttgcgctcatatttgcggacaagttatggggttcttccggtgcaataaactacgggcaggaagcaaggacattgataaacaatctttacaaccattgtgtagagcatggatcctatgtattaaagcccggtgacagatggggaggttcatcagtaacaaacccgtcatattttgcgcctgcatggtacaaagtgtatgctcaatatacaggagacacaagatggaatcaagtggcggacaagtgttaccaaattgttgaagaagttaagaaatacaacaacggaaccggccttgttcctgactggtgtactgcaagcggaactccggcaagcggtcagagttacgactacagatatgatgctacacgttacccgtggagaactgccgtggactattcatggtttggtgaccagagagcaaaggcaaactgcgatatgctgaccaaattctttgccagagacggggcaaaaggaatcgttgacggatacacaattcaaggttcaaaaattggcaacaatcacaacgcatcatttataggacctgttgcggcagcaagtatgacaggttacgatttgaactttgcaaaggaactttatagggagactgttgctgtaaaggacagtgaatattacggatattacggaaacaccttgagactgctcactttgttgtacataacaggaaacttcccgaatcctttgagtgacctttccggccaaccgacaccaccgtcgaatccgacaccttcattgcctcctcaggttgtttacggtgatgtaaatggcgacggtaatgttaactccactgatttgactatgttaaaaagatatctgctgaagagtgttaccaatataaacagagaggctgcagacgttaatcgtgacggtgcgattaactcctctgacatgactatattaaagagatatctgataaagagcataccccacctaccttatctcgagcaccaccaccaccaccac

SEQ ID NO: 21 - protein, 447 aa, Artificial Sequence
  Synthetic polypeptide
MGVPFNTKYPYGPTSIADNQSEVTAMLKAEWEDWKSKRITSNGAGGYKRVQRDASTNYDTVSEGMGYGLLLAVCFNEQALFDDLYRYVKSHFNGNGLMHWHIDANNNVTSHDGGDGAATDADEDIALALIFADKLWGSSGAINYGQEARTLINNLYNHCVEHGSYVLKPGDRWGGSSVTNPSYFAPAWYKVYAQYTGDTRWNQVADKCYQIVEEVKKYNNGTGLVPDWCTASGTPASGQSYDYKYDATRYPWRTAVDYSWFGDQRAKANCDMLTKFFARDGAKGIVDGYTIQGSKISNNHNASFIGPVAAASMTGYDLNFAKELYRETVAVKDSEYYGYYGNSLRLLTLLYITGNFPNPLSDLSGQPTPPSNPTPSLPPQVVYGDVNGDGNVNSTDLTMLKRYLLKSVTNINREAADVNRDGAINSSDMTILKRYLIKSIPHLPYLE

SEQ ID NO: 22 - protein, 453 aa, Artificial Sequence
  Synthetic polypeptide
MGVPFNTKYPYGPTSIADNQSEVTAMLKAEWEDWKSKRITSNGAGGYKRVQRDASTNYDTVSEGMGYGLLLAVCFNEQALFDDLYRYVKSHFNGNGLMHWHIDANNNVTSHDGGDGAATDADEDIALALIFADKLWGSSGAINYGQEARTLINNLYNHCVEHGSYVLKPGDRWGGSSVTNPSYFAPAWYKVYAQYTGDTRWNQVADKCYQIVEEVKKYNNGTGLVPDWCTASGTPASGQSYDYKYDATRYPWRTAVDYSWFGDQRAKANCDMLTKFFARDGAKGIVDGYTIQGSKISNNHNASFIGPVAAASMTGYDLNFAKELYRETVAVKDSEYYGYYGNSLRLLTLLYITGNFPNPLSDLSGQPTPPSNPTPSLPPQVVYGDVNGDGNVNSTDLTMLKRYLLKSVTNINREAADVNRDGAINSSDMTILKRYLIKSIPHLPYLEHHHHHH

SEQ ID NO: 23 - DNA, 1341 bp, Artificial Sequence
  Synthetic polynucleotide
atgggtgtgccttttaacacaaaatacccctatggtcctacttctattgccgataatcagtcggaagtaactgcaatgctcaaagcagaatgggaagactggaagagcaagagaattacctcgaacggtgcaggaggatacaagagagtacagcgtgatgcttccaccaattatgatacggtatccgaaggtatgggatacggacttcttttggcggtttgctttaacgaacaggctttgtttgacgatttataccgttacgtaaaatctcatttcaatggaaacggacttatgcactggcacattgatgccaacaacaatgttacaagtcatgacggcggcgacggtgcggcaaccgatgctgatgaggatattgcacttgcgctcatatttgcggacaagttatggggttcttccggtgcaataaactacgggcaggaagcaaggacattgataaacaatctttacaaccattgtgtagagcatggatcctatgtattaaagcccggtgacagatggggaggttcatcagtaacaaacccgtcatattttgcgcctgcatggtacaaagtgtatgctcaatatacaggagacacaagatggaatcaagtggcggacaagtgttaccaaattgttgaagaagttaagaaatacaacaacggaaccggccttgttcctgactggtgtactgcaagcggaactccggcaagcggtcagagttacgactacaaatatgatgctacacgttacccgtggagaactgccgtggactattcatggtttggtgaccagagagcaaaggcaaactgcgatatgctgaccaaattctttgccagagacggggcaaaaggaatcgttgacggatacacaattcaaggttcaaaaattagcaacaatcacaacgcatcatttataggacctgttgcggcagcaagtatgacaggttacgatttgaactttgcaaaggaactttatagggagactgttgctgtaaaggacagtgaatattacggatattacggaaacagcttgagactgctcactttgttgtacataacaggaaacttcccgaatcctttgagtgacctttccggccaaccgacaccaccgtcgaatccgacaccttcattgcctcctcaggttgtttacggtgatgtaaatggcgacggtaatgttaactccactgatttgactatgttaaaaagatatctgctgaagagtgttaccaatataaacagagaggctgcagacgttaatcgtgacggtgcgattaactcctctgacatgactatattaaagagatatctgataaagagcataccccacctaccttatctcgag

SEQ ID NO: 24 - DNA, 1359 bp, Artificial Sequence
  Synthetic polynucleotide
atgggtgtgccttttaacacaaaatacccctatggtcctacttctattgccgataatcagtcggaagtaactgcaatgctcaaagcagaatgggaagactggaagagcaagagaattacctcgaacggtgcaggaggatacaagagagtacagcgtgatgcttccaccaattatgatacggtatccgaaggtatgggatacggacttcttttggcggtttgctttaacgaacaggctttgtttgacgatttataccgttacgtaaaatctcatttcaatggaaacggacttatgcactggcacattgatgccaacaacaatgttacaagtcatgacggcggcgacggtgcggcaaccgatgctgatgaggatattgcacttgcgctcatatttgcggacaagttatggggttcttccggtgcaataaactacgggcaggaagcaaggacattgataaacaatctttacaaccattgtgtagagcatggatcctatgtattaaagcccggtgacagatggggaggttcatcagtaacaaacccgtcatattttgcgcctgcatggtacaaagtgtatgctcaatatacaggagacacaagatggaatcaagtggcggacaagtgttaccaaattgttgaagaagttaagaaatacaacaacggaaccggccttgttcctgactggtgtactgcaagcggaactccggcaagcggtcagagttacgactacaaatatgatgctacacgttacccgtggagaactgccgtggactattcatggtttggtgaccagagagcaaaggcaaactgcgatatgctgaccaaattctttgccagagacggggcaaaaggaatcgttgacggatacacaattcaaggttcaaaaattagcaacaatcacaacgcatcatttataggacctgttgcggcagcaagtatgacaggttacgatttgaactttgcaaaggaactttatagggagactgttgctgtaaaggacagtgaatattacggatattacggaaacagcttgagactgctcactttgttgtacataacaggaaacttcccgaatcctttgagtgacctttccggccaaccgacaccaccgtcgaatccgacaccttcattgcctcctcaggttgtttacggtgatgtaaatggcgacggtaatgttaactccactgatttgactatgttaaaaagatatctgctgaagagtgttaccaatataaacagagaggctgcagacgttaatcgtgacggtgcgattaactcctctgacatgactatattaaagagatatctgataaagagcataccccacctaccttatctcgagcaccaccaccaccaccac

SEQ ID NO: 25 - DNA, 20 bp, Artificial Sequence
  Primer
aagaaggagatataccatgg

SEQ ID NO: 26 - DNA, 18 bp, Artificial Sequence
  Primer
gtggtggtggtgctcgag

SEQ ID NO: 27 - DNA, 31 bp, Artificial Sequence
  Primer
caaggttcaaaaattnnsaacaatcacaacg

SEQ ID NO: 28 - DNA, 31 bp, Artificial Sequence
  Primer
cgttgtgattgttsnnaatttttgaaccttg

SEQ ID NO: 29 - protein, 453 aa, Artificial Sequence
  Synthetic polypeptide
MGVPFNTKYPYGPTSIADNQSEVTAMLKAEWEDWKSKRITSNGAGGYKRVQRDASTNYDTVSEGMGYGLLLAVCFNEQALFDDLYRYVKSHFNGNGLMHWHIDANNNVTSHDGGDGAATDADEDIALALIFADKLWGSSGAINYGQEARTLINNLYNHCVEHGSYVLKPGDRWGGSSVTNPSYFAPAWYKVYAQYTGDTRWNQVADKCYQIVEEVKKYNNGTGLVPDWCTASGTPASGQSYDYKYDATRYGWRTAVDYSWFGDQRAKANCDMLTKFFARDGAKGIVDGYTIQGSKIGNNHNASFIGPVAAASMTGYDLNFAKELYRETVAVKDSEYYGYYGNTLRLLTLLYITGNFPNPLSDLSGQPTPPSNPTPSLPPQVVYGDVNGDGNVNSTDLTMLKRYLLKSVTNINREAADVNRDGAINSSDMTILKRYLIKSIPHLPYLEHHHHHH

SEQ ID NO: 30 - DNA, 1359 bp, Artificial Sequence
  Sunthetic polynucleotide
atgggtgtgccttttaacacaaaatacccctatggtcctacttctattgccgataatcagtcggaagtaactgcaatgctcaaagcagaatgggaagactggaagagcaagagaattacctcgaacggtgcaggaggatacaagagagtacagcgtgatgcttccaccaattatgatacggtatccgaaggtatgggatacggacttcttttggcggtttgctttaacgaacaggctttgtttgacgatttataccgttacgtaaaatctcatttcaatggaaacggacttatgcactggcacattgatgccaacaacaatgttacaagtcatgacggcggcgacggtgcggcaaccgatgctgatgaggatattgcacttgcgctcatatttgcggacaagttatggggttcttccggtgcaataaactacgggcaggaagcaaggacattgataaacaatctttacaaccattgtgtagagcatggatcctatgtattaaagcccggtgacagatggggaggttcatcagtaacaaacccgtcatattttgcgcctgcatggtacaaagtgtatgctcaatatacaggagacacaagatggaatcaagtggcggacaagtgttaccaaattgttgaagaagttaagaaatacaacaacggaaccggccttgttcctgactggtgtactgcaagcggaactccggcaagcggtcagagttacgactacaaatatgatgctacacgttacggctggagaactgccgtggactattcatggtttggtgaccagagagcaaaggcaaactgcgatatgctgaccaaattctttgccagagacggggcaaaaggaatcgttgacggatacacaattcaaggttcaaaaattggcaacaatcacaacgcatcatttataggacctgttgcggcagcaagtatgacaggttacgatttgaactttgcaaaggaactttatagggagactgttgctgtaaaggacagtgaatattacggatattacggaaacaccttgagactgctcactttgttgtacataacaggaaacttcccgaatcctttgagtgacctttccggccaaccgacaccaccgtcgaatccgacaccttcattgcctcctcaggttgtttacggtgatgtaaatggcgacggtaatgttaactccactgatttgactatgttaaaaagatatctgctgaagagtgttaccaatataaacagagaggctgcagacgttaatcgtgacggtgcgattaactcctctgacatgactatattaaagagatatctgataaagagcataccccacctaccttatctcgagcaccaccaccaccaccac

SEQ ID NO: 31 - DNA, 33 bp, Artificial Sequence
  Primer
ggtatgggatacggaatgcttttggcggtttgc

SEQ ID NO: 32 - DNA, 33 bp, Artificial Sequence
  Primer
caggctttgtttgacggtttataccgttacgta

SEQ ID NO: 33 - DNA, 33 bp, Artificial Sequence
  Primer
acattgataaacaatatttacaaccattgtgta

SEQ ID NO: 34 - DNA, 32 bp, Artificial Sequence
  Primer
gcatggtacaaagtgtttgctcaatatacagg

SEQ ID NO: 35 - DNA, 33 bp, Artificial Sequence
  Primer
cttgtgtctcctgtaaattgagcatacactttg

SEQ ID NO: 36 - DNA, 33 bp, Artificial Sequence
  Primer
gatgctacacgttacccgtggagaactgccgtg

SEQ ID NO: 37 - DNA, 32 bp, Artificial Sequence
  Primer
gtggactattcatggtatggtgaccagagagc

SEQ ID NO: 38 - DNA, 35 bp, Artificial Sequence
  Primer
gttgacggatacacactgcaaggttcaaaaattag

SEQ ID NO: 39 - DNA, 36 bp, Artificial Sequence
  Primer
ggtgcaataaactacccgcaggaagcaaggacattg

SEQ ID NO: 40 - DNA, 36 bp, Artificial Sequence
  Primer
caatgtccttgcttcctgcgggtagtttattgcacc

SEQ ID NO: 41 - DNA, 36 bp, Artificial Sequence
  Primer
gaatattacggatattacccgaacagcttgagactg

SEQ ID NO: 42 - DNA, 36 bp, Artificial Sequence
  Primer
cagtctcaagctgttcgggtaatatccgtaatattc

SEQ ID NO: 43 - protein, 447 aa, Artificial Sequence
  Synthetic polypeptide
MGVPFNTKYPYGPTSIADNQSEVTAMLKAEWEDWKSKRITSNGAGGYKRVQRDASTNYDTVSEGMGYGLLLAVCFNEQALFDDLYRYVKSHFNGNGLMHWHIDANNNVTSHDGGDGAATDADEDIALALIFADKLWGSSGAINYGQEARTLINNLYNHCVEHGSYVLKPGDRWGGSSVTNPSYFAPAWYKVYAQYTGDTRWNQVADKCYQIVEEVKKYNNGTGLVPDWCTASGTPASGQSYDYKYDATRYGWRTAVDYSWFGDQRAKANCDMLTKFFARDGAKGIVDGYTIQGSKIGNNHNASFIGPVAAASMTGYDLNFAKELYRETVAVKDSEYYGYYGNTLRLLTLLYITGNFPNPLSDLSGQPTPPSNPTPSLPPQVVYGDVNGDGNVNSTDLTMLKRYLLKSVTNINREAADVNRDGAINSSDMTILKRYLIKSIPHLPYLE

SEQ ID NO: 44 - DNA, 1341 bp, Artificial Sequence
  Synthetic polynucleotide
atgggtgtgccttttaacacaaaatacccctatggtcctacttctattgccgataatcagtcggaagtaactgcaatgctcaaagcagaatgggaagactggaagagcaagagaattacctcgaacggtgcaggaggatacaagagagtacagcgtgatgcttccaccaattatgatacggtatccgaaggtatgggatacggacttcttttggcggtttgctttaacgaacaggctttgtttgacgatttataccgttacgtaaaatctcatttcaatggaaacggacttatgcactggcacattgatgccaacaacaatgttacaagtcatgacggcggcgacggtgcggcaaccgatgctgatgaggatattgcacttgcgctcatatttgcggacaagttatggggttcttccggtgcaataaactacgggcaggaagcaaggacattgataaacaatctttacaaccattgtgtagagcatggatcctatgtattaaagcccggtgacagatggggaggttcatcagtaacaaacccgtcatattttgcgcctgcatggtacaaagtgtatgctcaatatacaggagacacaagatggaatcaagtggcggacaagtgttaccaaattgttgaagaagttaagaaatacaacaacggaaccggccttgttcctgactggtgtactgcaagcggaactccggcaagcggtcagagttacgactacaaatatgatgctacacgttacggctggagaactgccgtggactattcatggtttggtgaccagagagcaaaggcaaactgcgatatgctgaccaaattctttgccagagacggggcaaaaggaatcgttgacggatacacaattcaaggttcaaaaattggcaacaatcacaacgcatcatttataggacctgttgcggcagcaagtatgacaggttacgatttgaactttgcaaaggaactttatagggagactgttgctgtaaaggacagtgaatattacggatattacggaaacaccttgagactgctcactttgttgtacataacaggaaacttcccgaatcctttgagtgacctttccggccaaccgacaccaccgtcgaatccgacaccttcattgcctcctcaggttgtttacggtgatgtaaatggcgacggtaatgttaactccactgatttgactatgttaaaaagatatctgctgaagagtgttaccaatataaacagagaggctgcagacgttaatcgtgacggtgcgattaactcctctgacatgactatattaaagagatatctgataaagagcataccccacctaccttatctcgag